(19) United States
(12) Patent Application Publication
(10) Pub. No.: US 2026/0059572 A1
(43) Pub. Date: Feb. 26, 2026

(54) Multiple Cell Initial Access Assistance

(71) Applicant: QUALCOMM Incorporated, San Diego, CA (US)

(72) Inventors: Aria HASANZADEZONUZY, Jersey City, NJ (US); Kianoush HOSSEINI, San Diego, CA (US); Umesh PHUYAL, San Diego, CA (US); Sherif ELAZZOUNI, San Diego, CA (US)

(21) Appl. No.: 18/811,666

(22) Filed: Aug. 21, 2024

(51) Int. Cl. H04W 74/0833; H04W 8/22; H04W 52/02; H04W 74/08

(52) U.S. Cl. CPC H04W 74/0833; H04W 8/22; H04W 52/0235; H04W 74/0866

(57) ABSTRACT

Certain aspects of the present disclosure provide techniques for assisted initial access between cells. A method generally includes obtaining, in an anchor cell of a first network entity, assistance information that indicates that the first network entity is capable of assisting, via the anchor cell, random access for a plurality of assisted cells of a second network entity; transmitting, in the anchor cell of the first network entity, a first random access signal to initiate a first random access channel (RACH) procedure in a first assisted cell of the plurality of assisted cells of the second network entity; and obtaining, in the anchor cell of the first network entity or in the first assisted cell of the second network entity, a second random access signal for the first RACH procedure comprising system information (SI) associated with the first assisted cell.

### INTRODUCTION

### Field of the Disclosure

Aspects of the present disclosure relate to wireless communications, and more particularly, to techniques for assisted initial access between cells.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining, in an anchor cell of a first network entity, assistance information that indicates that the first network entity is capable of assisting, via the anchor cell, random access for a plurality of assisted cells of a second network entity; transmitting, in the anchor cell of the first network entity, a first random access signal to initiate a first random access channel (RACH) procedure in a first assisted cell of the plurality of assisted cells of the second network entity; and obtaining, in the anchor cell of the first network entity or in the first assisted cell of the second network entity, a second random access signal for the first RACH procedure comprising system information (SI) associated with the first assisted cell.

Another aspect provides one or more apparatuses configured for wireless communications. The one or more apparatuses include one or more memories and one or more processors, coupled to the one or more memories, configured to cause the one or more apparatuses to obtain, in an anchor cell of a first network entity, assistance information that indicates that the first network entity is capable of assisting, via the anchor cell, random access for a plurality of assisted cells of a second network entity; transmit, in the anchor cell of the first network entity, a first random access signal to initiate a first RACH procedure in a first assisted cell of the plurality of assisted cells of the second network entity; and obtain, in the anchor cell of the first network entity or in the first assisted cell of the second network entity, a second random access signal for the first RACH procedure comprising SI associated with the first assisted cell.

Another aspect provides one or more apparatuses configured for wireless communications. The one or more apparatuses include means for obtaining, in an anchor cell of a first network entity, assistance information that indicates that the first network entity is capable of assisting, via the anchor cell, random access for a plurality of assisted cells of a second network entity; means for transmitting, in the anchor cell of the first network entity, a first random access signal to initiate a first RACH procedure in a first assisted cell of the plurality of assisted cells of the second network entity; and means for obtaining, in the anchor cell of the first network entity or in the first assisted cell of the second network entity, a second random access signal for the first RACH procedure comprising SI associated with the first assisted cell.

Another aspect provides one or more non-transitory computer-readable media. The one or more non-transitory computer-readable media include executable instructions that, when executed by one or more processors of one or more apparatuses, cause the one or more apparatuses to obtain, in an anchor cell of a first network entity, assistance information that indicates that the first network entity is capable of assisting, via the anchor cell, random access for a plurality of assisted cells of a second network entity; transmit, in the anchor cell of the first network entity, a first random access signal to initiate a first RACH procedure in a first assisted cell of the plurality of assisted cells of the second network entity; and obtain, in the anchor cell of the first network entity or in the first assisted cell of the second network entity, a second random access signal for the first RACH procedure comprising SI associated with the first assisted cell.

In some examples of the methods, apparatuses, and non-transitory computer-readable media described herein, the first network entity is associated with a first RAN; and the second network entity is associated with a second RAN.

In some examples of the methods, apparatuses, and non-transitory computer-readable media described herein, obtaining the assistance information comprises obtaining, in the anchor cell of the first network entity, a synchronization signal block, a system information block, or a broadcast signal comprising the assistance information.

In some examples of the methods, apparatuses, and non-transitory computer-readable media described herein, the assistance information further indicates a number of the plurality of assisted cells of the second network entity that the first network entity is capable of assisting.

Some examples of the methods, apparatuses, and non-transitory computer-readable media described herein may further include operations, features, means, or instructions for obtaining an indication of one or more time-frequency resources corresponding to one or more random access occasions, wherein the one or more time-frequency resources correspond to an anchor carrier frequency of the anchor cell, and wherein transmitting the first random access signal comprises transmitting the first random access signal on at least one of the one or more time-frequency resources.

Some examples of the methods, apparatuses, and non-transitory computer-readable media described herein may further include operations, features, means, or instructions for obtaining, in the anchor cell of the first network entity, a third random access signal for the first RACH procedure, after transmitting the first random access signal, and before obtaining the second random access signal, the third random access signal comprising: an indication of one or more time-frequency resources corresponding to one or more random access occasions; and a temporary C-RNTI associated with the second random access signal.

In some examples of the methods, apparatuses, and non-transitory computer-readable media described herein, the second random access signal is scrambled with the C-RNTI.

In some examples of the methods, apparatuses, and non-transitory computer-readable media described herein, a frequency of the one or more time-frequency resources corresponds to: an anchor carrier frequency of the anchor cell, or a first carrier frequency of the first assisted cell. Some examples of the methods, apparatuses, and non-transitory computer-readable media described herein may further include operations, features, means, or instructions for transmitting, on the one or more time-frequency resources, a fourth random access signal, prior to obtaining the second random access signal.

In some examples of the methods, apparatuses, and non-transitory computer-readable media described herein, obtaining the second random access signal comprises obtaining the second random access signal in the first assisted cell of the second network entity.

In some examples of the methods, apparatuses, and non-transitory computer-readable media described herein, obtaining the second random access signal comprises obtaining the second random access signal in the anchor cell of the first network entity.

In some examples of the methods, apparatuses, and non-transitory computer-readable media described herein, the second random access signal further comprises an indication of one or more time-frequency resources reserved for communication with the second network entity in the first assisted cell of the second network entity.

In some examples of the methods, apparatuses, and non-transitory computer-readable media described herein, the second random access signal further comprises a temporary C-RNTI.

Some examples of the methods, apparatuses, and non-transitory computer-readable media described herein may further include operations, features, means, or instructions for transmitting, in the anchor cell of the first network entity, a third random access signal to initiate a second RACH procedure in a second assisted cell of the plurality of assisted cells of the second network entity; and based on failure of the second RACH procedure to successfully complete within a time duration after the third random access signal is transmitted, transmit, in the anchor cell of the first network entity, a fourth random access signal to initiate a third RACH procedure in the anchor cell.

Some examples of the methods, apparatuses, and non-transitory computer-readable media described herein may further include operations, features, means, or instructions for obtaining an indication of the time duration.

Some examples of the methods, apparatuses, and non-transitory computer-readable media described herein may further include operations, features, means, or instructions for obtaining an indication of one or more time-frequency resources corresponding to the fourth random access signal based on the failure of the second RACH procedure.

In some examples of the methods, apparatuses, and non-transitory computer-readable media described herein, the SI associated with the first assisted cell comprises at least one of: a RACH configuration; an initial downlink bandwidth part; an initial uplink bandwidth part; a time division duplex pattern; or a physical cell identifier.

Another aspect provides a method for wireless communications by an apparatus. The method includes transmitting, in an anchor cell of the apparatus, assistance information indicating that the apparatus is capable of assisting, via the anchor cell, a RACH procedure in a plurality of assisted cells of a network entity; and obtaining, in the anchor cell, a first random access signal to initiate a first RACH procedure in a first assisted cell of the plurality of assisted cells of the network entity.

Another aspect provides one or more apparatuses configured for wireless communications. The one or more apparatuses include one or more memories and one or more processors, coupled to the one or more memories, configured to cause the one or more apparatuses to transmit, in an anchor cell of the apparatus, assistance information indicating that the apparatus is capable of assisting, via the anchor cell, a RACH procedure in a plurality of assisted cells of a network entity; and obtain, in the anchor cell, a first random access signal to initiate a first RACH procedure in a first assisted cell of the plurality of assisted cells of the network entity.

Another aspect provides one or more apparatuses configured for wireless communications. The one or more apparatuses include means for transmitting, in an anchor cell of the apparatus, assistance information indicating that the apparatus is capable of assisting, via the anchor cell, a RACH procedure in a plurality of assisted cells of a network entity; and means for obtaining, in the anchor cell, a first random access signal to initiate a first RACH procedure in a first assisted cell of the plurality of assisted cells of the network entity.

Another aspect provides one or more non-transitory computer-readable media. The one or more non-transitory computer-readable media include executable instructions that, when executed by one or more processors of one or more apparatuses, cause the one or more apparatuses to transmit, in an anchor cell of the apparatus, assistance information indicating that the apparatus is capable of assisting, via the anchor cell, a RACH procedure in a plurality of assisted cells of a network entity; and obtain, in the anchor cell, a first random access signal to initiate a first RACH procedure in a first assisted cell of the plurality of assisted cells of the network entity

Some examples of the methods, apparatuses, and non-transitory computer-readable media described herein may further include operations, features, means, or instructions for transmitting, in the anchor cell of the apparatus, a second random access signal for the first RACH procedure comprising SI associated with the first assisted cell.

In some examples of the methods, apparatuses, and non-transitory computer-readable media described herein, the second random access signal further comprises an indication of one or more time-frequency resources reserved for communication with the network entity in the first assisted cell of the network entity.

In some examples of the methods, apparatuses, and non-transitory computer-readable media described herein, the second random access signal further comprises a temporary C-RNTI.

In some examples of the methods, apparatuses, and non-transitory computer-readable media described herein, the SI associated with the first assisted cell comprises at least one of: a RACH configuration; an initial downlink bandwidth part; an initial uplink bandwidth part; a time division duplex pattern; or a physical cell identifier.

In some examples of the methods, apparatuses, and non-transitory computer-readable media described herein, the apparatus is associated with a first RAN; and the network entity is associated with a second RAN.

In some examples of the methods, apparatuses, and non-transitory computer-readable media described herein, transmitting the assistance information comprises transmitting, in the anchor cell of the apparatus, a synchronization signal block, a system information block, or a broadcast signal comprising the assistance information.

In some examples of the methods, apparatuses, and non-transitory computer-readable media described herein, the assistance information further indicates a number of the plurality of assisted cells of the network entity that the apparatus is capable of assisting.

Some examples of the methods, apparatuses, and non-transitory computer-readable media described herein may further include operations, features, means, or instructions for transmitting an indication of one or more time-frequency resources corresponding to one or more random access occasions, wherein the one or more time-frequency resources correspond to an anchor carrier frequency of the anchor cell, and wherein obtaining the first random access signal comprises obtaining the first random access signal on at least one of the one or more time-frequency resources.

Some examples of the methods, apparatuses, and non-transitory computer-readable media described herein may further include operations, features, means, or instructions for transmitting, in the anchor cell of the apparatus, a second random access signal for the first RACH procedure after obtaining the first random access signal, the second random access signal comprising: an indication of one or more time-frequency resources corresponding to one or more random access occasions; and a temporary C-RNTI.

In some examples of the methods, apparatuses, and non-transitory computer-readable media described herein, a frequency of the one or more time-frequency resources corresponds to: an anchor carrier frequency of the anchor cell, or a first carrier frequency of the first assisted cell.

Some examples of the methods, apparatuses, and non-transitory computer-readable media described herein may further include operations, features, means, or instructions for transmitting, to the network entity, a WUS comprising an indication to transition the first assisted cell from a sleep state to an awake state to enable the network entity to communicate in the first assisted cell.

In some examples of the methods, apparatuses, and non-transitory computer-readable media described herein, the WUS further comprises one or more of: at least a part of the first random access signal; a signal quality of the first random access signal; the indication of the one or more time-frequency resources corresponding to the one or more random access occasions; or the temporary C-RNTI.

In some examples of the methods, apparatuses, and non-transitory computer-readable media described herein, the WUS further comprises an indication of a time duration to wait to receive a third random access signal before returning to the sleep state.

Some examples of the methods, apparatuses, and non-transitory computer-readable media described herein may further include operations, features, means, or instructions for obtaining an indication that the first assisted cell is returning to the sleep state.

Some examples of the methods, apparatuses, and non-transitory computer-readable media described herein may further include operations, features, means, or instructions for obtaining, in the anchor cell, a second random access signal to initiate a second RACH procedure in the anchor cell.

Some examples of the methods, apparatuses, and non-transitory computer-readable media described herein may further include operations, features, means, or instructions for transmitting, in the anchor cell, an indication of a time duration to wait for the first RACH procedure in the first assisted cell to complete before determining the first RACH procedure has failed and initiating a second RACH procedure in the anchor cell.

Some examples of the methods, apparatuses, and non-transitory computer-readable media described herein may further include operations, features, means, or instructions for transmitting, in the anchor cell, an indication of one or more time-frequency resources to use to initiate a second RACH procedure in the anchor cell based on a failure of the first RACH procedure in the first assisted cell.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A is an example process flow diagram depicting an example random access procedure performed between a UE and a network entity to establish a radio resource control connection.

FIG. 5B is an example process flow diagram depicting another example random access procedure performed between a UE and a network entity to establish a radio resource control connection.

FIG. 6 depicts an example wireless communications system that supports techniques for assisted access to a cell for wireless communications.

FIG. 7 depicts a process flow for communications in a network between a UE, a first network entity, and a second network entity for assisted initial access.

FIG. 8 depicts another process flow for communications in a network between a UE, a first network entity, and a second network entity for assisted initial access.

FIG. 9 depicts another process flow for communications in a network between a UE, a first network entity, and a second network entity for assisted initial access.

FIG. 10 depicts a method for wireless communications.

FIG. 11 depicts another method for wireless communications.

FIG. 12 depicts aspects of an example communications device.

FIG. 13 depicts aspects of another example communications device.

### DETAILED DESCRIPTION

Aspects of the present disclosure provide apparatuses, methods, processing systems, and computer-readable mediums for inter-cell initial access assistance for multiple cells.

As future generations of radio access technologies (RATs) (e.g., such as 6G wireless technologies and/or other generations of wireless technologies) are developed and deployed, many wireless communications networks may support multiple RATs, such as during a “migration period.” A migration period may refer to a period of time for rolling out a new generation of wireless technology across new and/or existing spectrum. For example, during a migration period, wireless communications networks may support both 5G and 6G devices as wireless devices are gradually “migrated” to 6G devices. Further, 5G bands may be utilized for the 6G rollout to help ensure a smooth transition to 6G (e.g., aggregating spectrum across generations).

Technical problems associated with supporting multiple RANs, such as with different RATs, in a wireless communications network, (e.g., such as during migration or new RAT adoption) may include problems with power consumption and/or network energy savings. For example, a first network entity, implementing a first RAT and associated with a first RAN, such as 5G, and a second network entity, implementing a second RAT and associated with a second RAN, such as 6G may be deployed in a network. Each of the first network entity and the second network entity may provide communications coverage for a respective coverage area, which may be referred to as a “cell.” For example, the first network entity may be associated with a 5G cell used to serve 5G wireless devices, and the second network entity may be associated with a 6G cell used to serve 6G wireless devices. In some cases, the 6G cell, however, may not include any 6G-capable devices (e.g., user equipments (UEs)), and thus the second network entity may not be serving any 6G wireless devices in the 6G cell. This may cause increased power consumption at the second network entity and/or contribute to reduced network energy savings. Similar problems may also exist in cases where there are multiple RANs with the same RAT (e.g., such as a first 5G RAN including a first 5G RAT supporting a first 5G cell and a second 5G RAN including a second 5G RAT supporting a second 5G cell, where the second 5G cell, for example, is not serving any 5G devices).

In certain aspects, when a cell does not include any wireless devices and thus a network entity is not connected to any wireless devices in the cell, then the cell may be placed in a deep level of sleep. Placing the cell in the deep level of sleep when such conditions are met may allow for power and/or network energy savings. As used herein, placing a cell in a deep level of sleep (e.g., a sleep state) may refer to switching a transceiver of the network entity to a sleep state such that the network entity is unable to establish a connection and/or communicate with other wireless devices in the cell, such as for a period of time, periodically, etc. Although aspects herein describe placing a cell in a sleep state when the cell does not include any wireless devices, in some other cases, the cell may remain in an awake state; however, communication within the cell (e.g., transmission and/or reception) may be stopped (e.g., cell-specific system information may not be broadcast in a cell that does not include any wireless devices).

In some cases, after the network entity serving the cell enters into a sleep state (or stops communicating in the cell, including stopping broadcasting cell-specific system information), a wireless device, such as a UE, may re-locate to within the coverage area of the cell. While within the cell, the UE may request to connect to the network entity to obtain initial access to a radio access network (RAN) associated with the network entity. In certain aspects, the UE may attempt to initiate a random access procedure (also commonly referred to as a “random access channel (RACH) procedure”) between the UE and the network entity, in the cell, to obtain initial access to the RAN. It should be noted that performing a random access procedure in the particular cell (e.g., to establish a connection with the network entity associated with the cell) may refer to using a carrier associated with that cell for communicating RACH messages between the UE and the network entity. However, because the cell is in a sleep state (or communication (e.g., transmission/reception) in the cell has stopped), the RACH procedure may fail (e.g., at least due to an inability of the network entity to communicate the RACH messages with the UE in the cell).

Thus, in certain aspects, inter-cell initial access assistance may be utilized. For example, a first cell may be used to assist initial access (simply referred to herein as “access”) of a UE in a second cell that is in a deep level of sleep. The first cell may be referred to as an “anchor cell,” which is a cell that supports a RACH procedure. More specifically, the anchor cell is a cell where synchronization and system information (SI) signaling (e.g., synchronization signal block (SSB) and system information block (SIB) transmission(s)) is supported. The second cell may be referred to as an “assisted cell.” As used herein, an anchor cell assisting a UE to access an assisted cell may refer to a first network entity communicating with the UE in the anchor cell to assist the UE in establishing a radio resource control (RRC) connection with a second network entity in the assisted cell to allow for communications between the second network entity and the UE in the assisted cell. In certain aspects, the first network entity is associated with a first RAN (e.g., a 5G RAN, such that the anchor cell is a 5G cell) and the second network entity is associated with a second RAN (e.g., a 6G RAN, such that the assisted cell is a 6G cell).

For example, a first network entity (e.g., associated with a 5G RAN) may exchange signaling with a UE in an anchor cell (e.g., a 5G cell) to enable the UE to establish a connection with and communicate with a second network entity (e.g., associated with a 6G RAN) in an assisted cell (e.g., a 6G cell). Specifically, the UE may receive a broadcast SI message, such as a SIB 1 (SIB1), from the first network entity in the anchor cell. The SIB1 may include system information usable for communicating with the second network entity in the assisted cell. The UE may use the received system information to send a first random access signal, such as a RACH preamble message, to the first network entity in the anchor cell. The RACH preamble message may be associated with the assisted cell, and thus, may be sent, by the UE, to initiate the establishment of a connection with the second network entity in the assisted cell.

In certain aspects, based at least in part on receiving the RACH preamble message, the first network entity may send signaling to the second network entity indicating to wake up the assisted cell (e.g., the 6G cell) for UE access in the assisted cell. For example, the signaling may include a wake up signal (WUS), which is a power saving mechanism that, when sent, acts as an indicator to wake up a device and/or a cell in a sleep state (e.g., transition to an awake state). In certain aspects, the first network entity may send at least part of the first random access signal, received from the UE, to the second network entity. In certain aspects, where the assisted cell is not in a sleep state but communication in the assisted cell has previously stopped, the signaling sent to second network entity may indicate to begin/resume communicating in the assisted cell.

The UE may receive, based on sending the RACH preamble message, a random access response message that indicates an uplink resource. In some cases, the random access response message may be sent in the anchor cell or the assisted cell. The UE may send, in response to receiving the random access response message, an uplink message on the uplink resource, and the uplink resource may be an uplink resource of the anchor cell or an uplink resource of the assisted cell. The UE may receive, based on sending the uplink message, a downlink message on a downlink resource, and the downlink resource may be a downlink resource of the anchor cell or a downlink resource of the assisted cell. Subsequent to receiving the downlink message, the UE and the second network entity may begin communicating with one another, in the assisted cell, if access to the second network entity in the assisted cell has been granted.

Thus, the “assistance” provided by the anchor cell may include (1) providing the UE with system information associated with the assisted cell and/or (2) waking up the assisted cell such that the second network entity can perform the RACH procedure and establish a connection in the assisted cell.

While in the above example, the anchor cell (e.g., the 5G cell) is assisting only the single assisted cell (e.g., the single 6G cell), in some other examples, the anchor cell may be used to assist access of UEs in multiple assisted cells (e.g., multiple 6G cells). Put differently, the anchor cell may provide assistance to multiple assisted cells. In certain aspects, each of the multiple assisted cells may be in a sleep state (or alternatively, transmission/reception in the assisted cells may be stopped). Providing assistance for multiple assisted cells may include, at least, providing UE(s) with system information for each respective assisted cell. Different techniques may be used to provide such system information.

In certain aspects, such as according to a first technique, the system information associated with each assisted cell may be provided in a SIB1 broadcast by a network entity in the anchor cell. For example, a 5G SIB1, broadcast by a first network entity associated with a 5G RAN, may be extended to include system information associated with each assisted 6G cell. In some cases, a number of available time-frequency resources may be insufficient to increase the payload of the SIB1 as such. In some other cases, there may be sufficient time-frequency resources; however, this technique may result in increased resource consumption, which may exhaust the available resources.

In certain aspects, such as according to a second technique, other SIB(s) (e.g., other than SIB1), broadcast by the network entity in the anchor cell, may be used to carry the system information associated with each assisted cell. Other SIB(s) are generally broadcast less frequently than the SIB1, however. Thus, using this second technique, initial access by a UE in one of the assisted cells may be delayed (e.g., while waiting to receive the SIB carrying the system information associated with that assisted cell).

In certain aspects, such as according to a third technique, similar to the second technique, other SIB(s) (e.g., other than SIB1) may be used to carry the system information associated with each assisted cell. However, unlike the second technique, in the third technique, the frequency of sending the other SIB(s) may be increased to reduce initial access delay. Increasing the frequency to achieve reduced initial access delay, however, may be at the cost of increased network power consumption and/or resource consumption in the anchor cell. For example, increasing the frequency of other SIB(s) transmission may increase transmission overhead in the anchor cell. In some cases, this increase in transmission overhead (leading to increased power and resource consumption) may be wasted at least for SIB(s) that are used to carry system information associated with assisted cell(s) where no initial access attempt(s) are made (e.g., UE(s) are not initiating any RACH procedure(s) in these assisted cell(s)).

Accordingly, some techniques for assisting multiple assisted cells with initial access (e.g., by providing system information associated with each of the multiple assisted cells) may suffer from the technical problems of increased initial access delay, increased network power consumption, and/or increased resource consumption.

Certain aspects described herein overcome the aforementioned technical problems associated with assisting multiple cells and provide a technical benefit to the field of telecommunications. For example, aspects described herein provide techniques for efficient inter-cell initial access assistance for multiple cells. More specifically, in certain aspects, an anchor cell may be used to assist initial access of UEs in multiple assisted cells (e.g., that are each in a deep level of sleep) such as with (1) no or reduced extra initial access delay and (2) no or reduced extra power and/or resource consumption. An anchor cell assisting a UE in accessing one of the multiple assisted cells may refer to a first network entity communicating with the UE in the anchor cell to assist the UE in establishing an RRC connection with a second network entity in one of the assisted cell (e.g., which the anchor cell is assisting).

For example, instead of providing the UE with system information for each assisted cell that the anchor cell assists (as done in some techniques, as described above), the first network entity may send to the UE, in the anchor cell, assistance information indicating that the first network entity is capable of assisting initial access for multiple assisted cells. In response to receiving the assistance information, the UE may send, in the anchor cell of the first network entity, a first random access signal (e.g., a RACH preamble) to initiate a RACH procedure in one of the assisted cells. For example, the UE may request to establish an RRC connection in a first assisted cell among the cells assisted by the first network entity/anchor cell. In certain aspects, the first assisted cell may be in a sleep state; thus, after receiving the UE's request, the first network entity may send an indication, to a second network entity associated with the first assisted cell, to “wake up” the first assisted cell. In certain aspects, the first assisted cell may be in an awake state; thus, after receiving the UE's request, the first network entity may send an indication, to the second network entity, indicating to begin communicating (e.g., transmit and/or receive) in the first assisted cell.

In certain aspects, the UE may complete the RACH procedure in the first assisted cell to establish an RRC connection with the second network entity. For example, the first network entity may send, to the UE in the anchor cell, an indication of time-frequency resources corresponding to random access occasion(s) that may be used for performing the RACH procedure with the second network entity, in the first assisted cell. During the RACH procedure, the UE may obtain, from the second network entity in the first assisted cell, the system information associated with the first assisted cell. The UE may use the system information to connect to and communicate with the second network entity in the first assisted cell.

In certain other aspects, the UE may complete the RACH procedure in the anchor cell to establish an RRC connection with the second network entity. Completing the RACH procedure in the anchor cell may help to reduce delay associated with waiting for the first assisted cell to wake up to complete the RACH procedure, in some cases. During the RACH procedure, the UE may obtain, from the first network entity in the anchor cell, the system information associated with the first assisted cell. The UE may use the system information to connect to and communicate with the second network entity in the first assisted cell.

Certain techniques for inter-cell initial access assistance for multiple cells (e.g., assisted cells) described herein may provide various beneficial technical effects and/or advantages. The techniques for providing assistance to multiple assisted cells may enable improved wireless communications performance, such as (1) reduced initial access delay (e.g., with a network entity associated with an assisted cell) and/or (2) reduced power and/or resource consumption. The improved wireless communications performance may be attributable to reduced system information transmission. For example, assistance information may be sent to a UE seeking to establish an RRC connection in an assisted cell, and based on this information the UE may initiate a RACH procedure in a single one of the assisted cells and thus receive only the system information associated with the single assisted cell. Accordingly, the transmission (e.g., broadcast) of system information associated with other assisted cells may be avoided.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

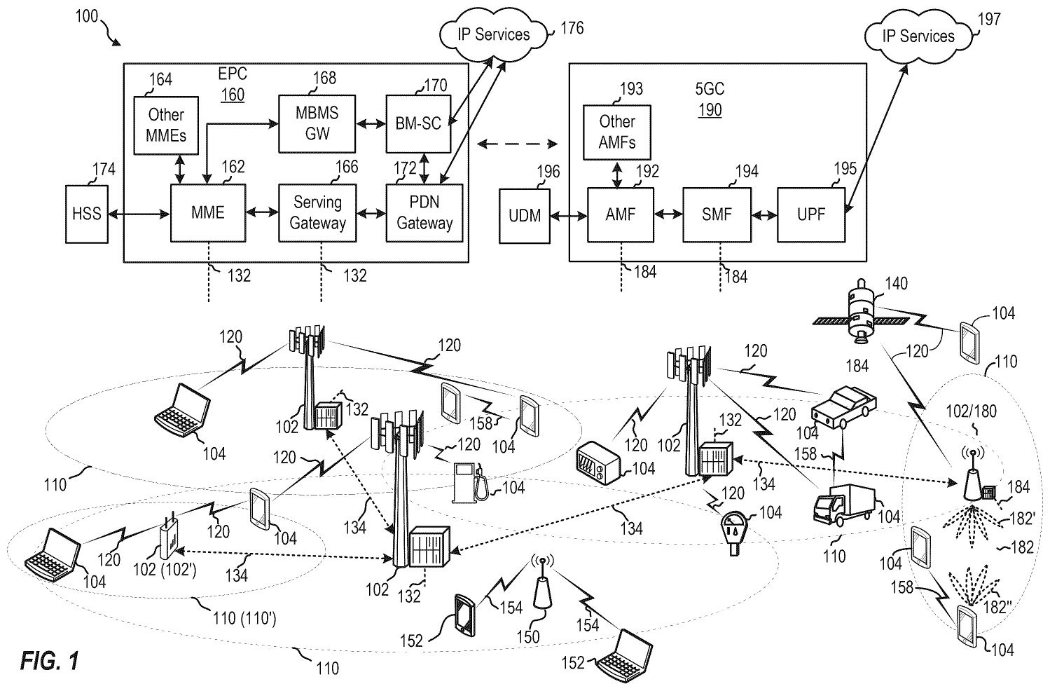

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

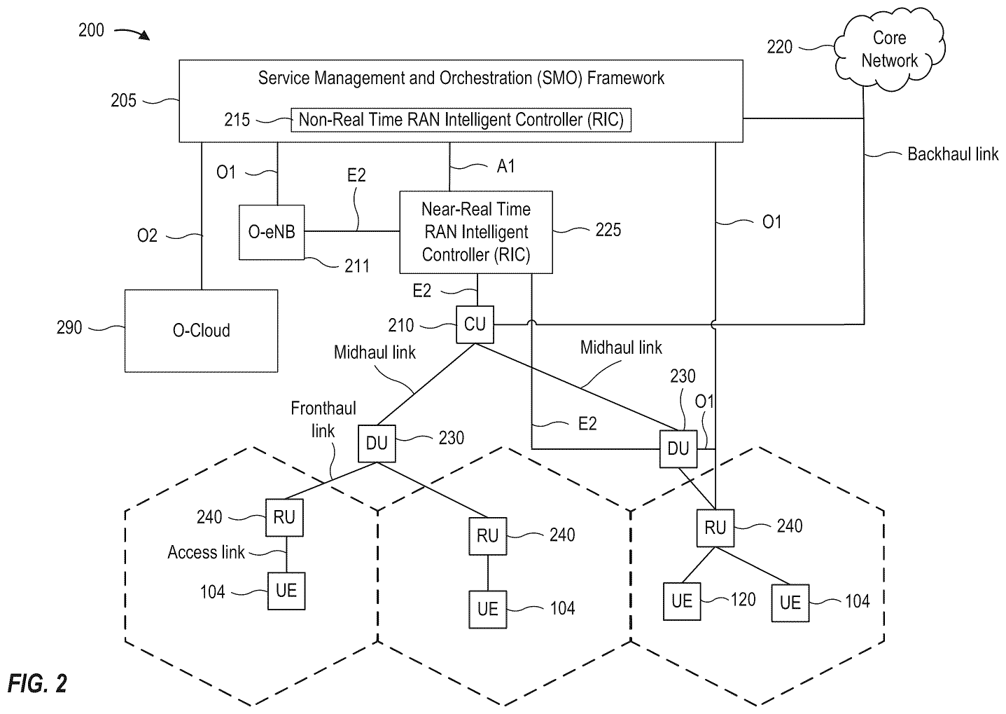

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., an mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

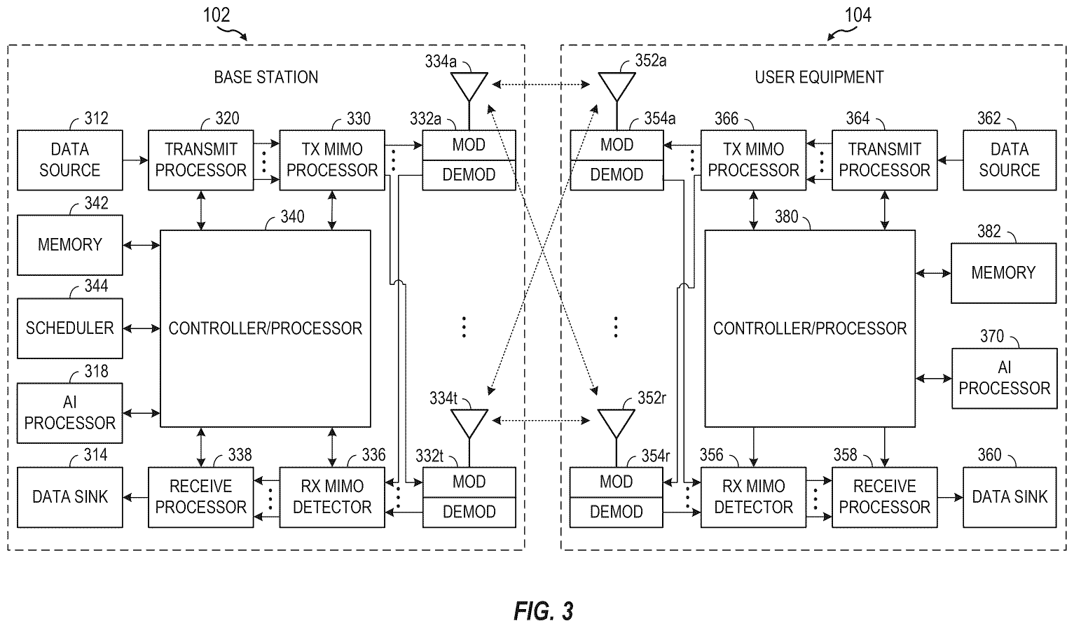

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

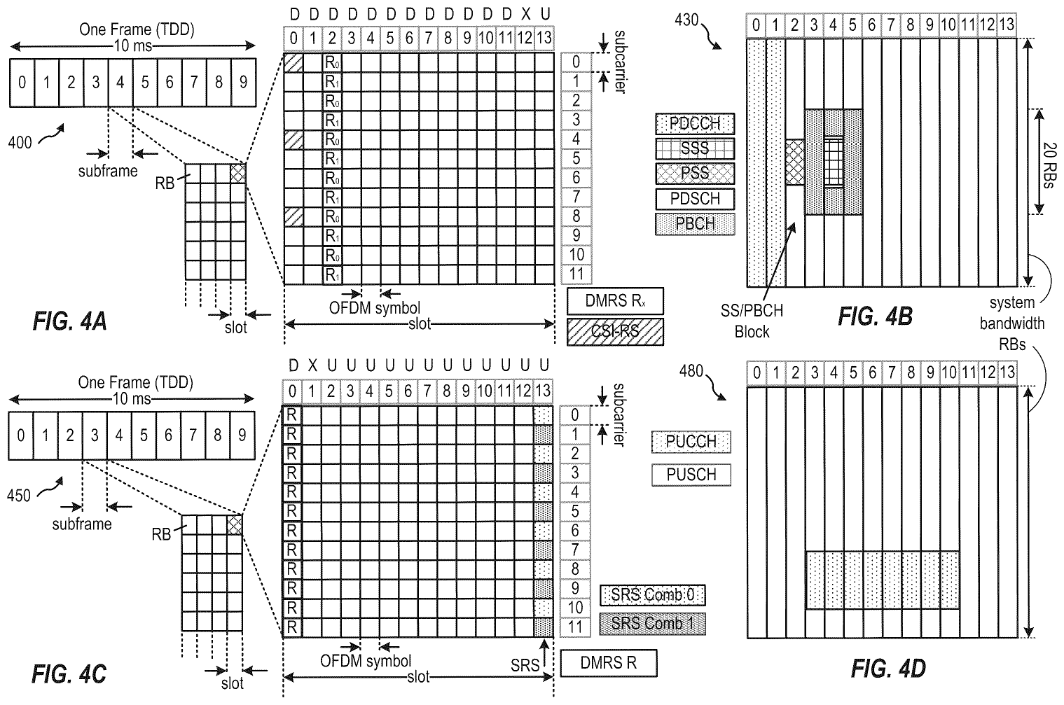

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures for Initial Access

Certain wireless communication systems (e.g., an E-UTRA system and/or 5G NR system) may provide a specified channel for random access, such as a RACH, and corresponding random access procedures. In certain aspects, a UE (e.g., such as UE 104 depicted and described with respect to FIGS. 1 and 3) may use the RACH for initial access to a RAN. For example, a random access procedure may be performed to transition the UE from an idle state (e.g., RRC idle) to a connected state (e.g., RRC connection).

As used herein, RRC states of a UE in a RAN include (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), and (3) an idle state (also referred to as an “idle mode,” “RRC idle mode,” and/or “RRC idle state”). The UE may be operating in a connected state in the RAN after establishing an RRC connection with a network entity in the RAN. The UE may be operating in an idle state in the RAN when the UE is not connected, or in other words, does not have an established RRC connection with the network entity in the RAN. The UE may be operating in an inactive state in the RAN when the UE has an established RRC connection with the network entity in the RAN, but the connection is in a dormant, suspended, or inactive and there is no active communication between the UE and the network entity. For example, while operating in the inactive state, unlike the idle state, a non-access stratum (NAS) layer of an RRC connection established by the UE may continue to be connected.

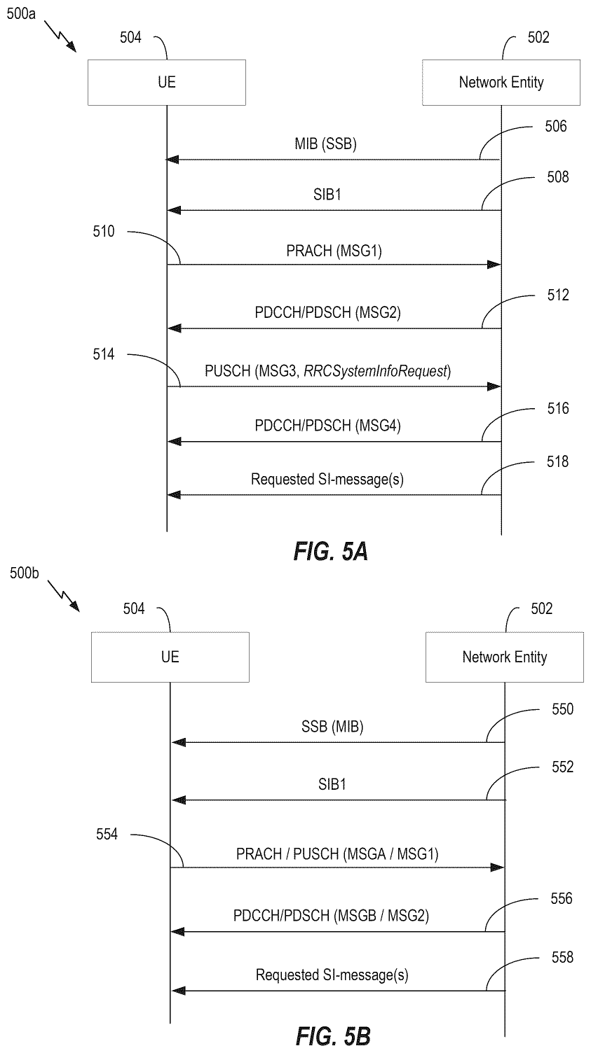

FIG. 5A depicts a process flow diagram of an example RACH procedure 500a (referred to as a “four-step RACH procedure”) performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may begin, at 506, with the network entity 502 broadcasting and the UE 504 receiving an MIB. The MIB may be carried by the PBCH, which, as described above, may be logically grouped with a PSS and a SSS to form a SS/PBCH block, and in some cases, referred to as an SSB. The MIB may be the first, among other SIBs, which may also be broadcasted by network entity 502. The MIB may be a control channel message transmitted by network entity 502 that provides information for UE 504 to synchronize with the network and access a cell of network entity 502. Network entity 502 may transmit MIBs periodically.

The RACH procedure 500a then proceeds, at 508, with the network entity 502 broadcasting and the UE 504 receiving a SIB1. The SIB1 may carry basic information that UE 504 may use to perform initial attachment to the RAN and network entity 502.

At 510, the UE 504 sends a first message (MSG1) to the network entity 502 on a physical random access channel (PRACH). In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access (CBRA), the preamble sequence may be randomly selected among a set of preamble sequences (e.g., up to 64 sequences in some cases). The preamble signature may be used to identify the UE 504 for scheduling communications (e.g., MSG2 and MSG3) with the network entity 502. The term “RACH preamble” may refer to or correspond to “random access preamble,” “preamble,” “preamble sequence,” and/or “preamble signature.”

At 512, the network entity 502 responds with a random access response (RAR) message (MSG2). For example, the network entity 502 may send a PDCCH communication including DCI that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble signature and indicate that the RAR is for the UE 504 that transmitted MSG1 at 510. As an example, the RAPID may identify a particular frequency resource used for the preamble transmission. The backoff parameter value may be used to determine a RACH occasion (RO) for sending a subsequent RACH transmission (e.g., a preamble transmission). An RO may correspond to one or more time-frequency resources available for transmitting a preamble on a RACH.

At 514, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (e.g., for an UL transmission). As an example, MSG3 may use the time-frequency resource(s) indicated in the UL grant of the RAR. In some examples, MSG3 may include a bitmap of one or more requested SI messages.

At 516, the network entity 502 sends a contention resolution message (MSG4) in response to MSG3. In some cases, if the UE 504 is unable to receive or decode MSG3 and/or MSG4, the UE 504 may repeat RACH procedure 500a.

After receiving MSG4 at 516, UE 504 monitors for other system information (OSI) (e.g., SIBs other than SIB1). Based on the monitoring, UE 504 may receive, at 518, SI message(s) (e.g., requested SI message(s)).

In some cases, to reduce the latency associated with random access, another RACH procedure may be used, such as a two-step RACH procedure instead of a four-step RACH procedure (e.g., RACH procedure 500a). As the name implies, the two-step RACH procedure may effectively consolidate the four messages of the four-step RACH procedure into two messages.

FIG. 5B depicts a process flow diagram of another example RACH procedure 500b (referred to as a “two-step RACH procedure”) performed between the UE 504 and the network entity 502. The RACH procedure 500b may optionally begin at 550, where the network entity 502 broadcasts and the UE 504 receives a MIB, for example within an SSB. Further, at 552, the network entity 502 broadcasts and the UE 504 receives a SIB1 (e.g., steps 550 and 552 in the RACH procedure 500b may be similar to steps 506 and 508 in the RACH procedure 500a). The SIB1 may include random access resources in SI-RequestConfig, where the RA resources are linked to requested SI messages.

At 554, the UE 504 sends a first message (MSG1 or MSGA) to the network entity 502, which may effectively combine MSG1 and MSG3 described above with respect to FIG. 5A. In some aspects, MSG1/MSGA includes a RACH preamble for random access and a payload. For example, the payload may include a UE-ID and other signaling information, such as a buffer status report and/or a scheduling request. The RACH preamble of MSG1/MSGA may be transmitted over the RACH, and the payload of MSGA may be transmitted over the PUSCH, for example.

At 556, the network entity 502 sends a random access response message (MSG2 or MSGB), which may effectively combine MSG2 and MSG4 described above with respect to FIG. 5A. For example, MSGB may include a RAPID.

After receiving MSG2/MSGB, UE 504 monitors for OSI. Based on the monitoring, UE 504 may receive, at 558, SI message(s) (e.g., requested SI message(s)).

### Example Inter-Cell Initial Access Assistance

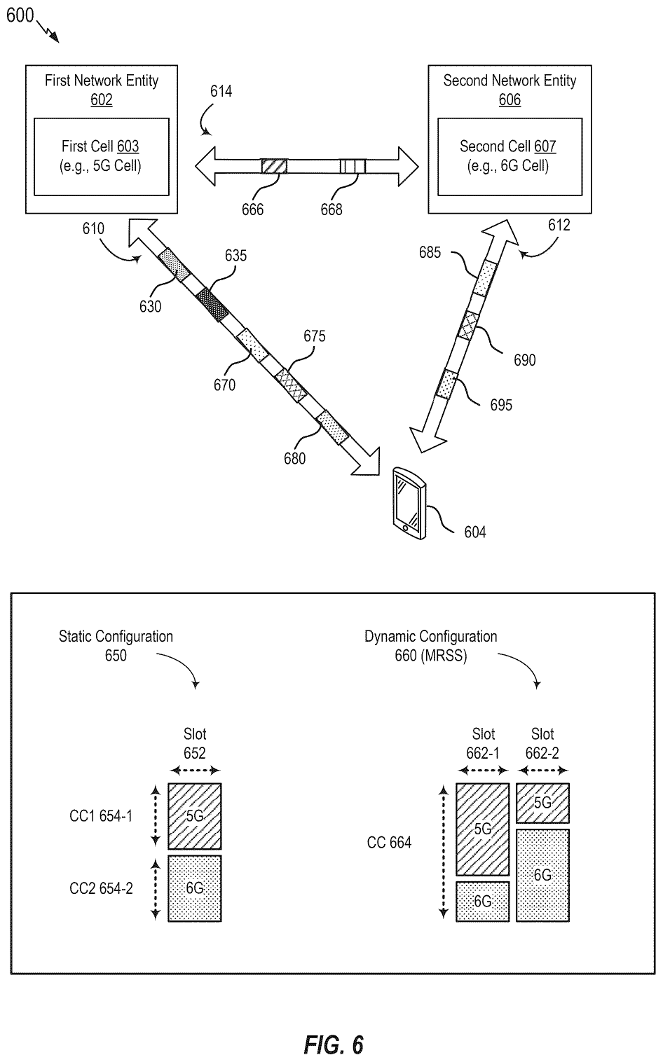

FIG. 6 depicts an example of a wireless communications system 600 that supports techniques for assisted access to an assisted cell.

The wireless communications system 600 may include a UE 604, a first network entity 602 associated with (e.g., supporting) a first cell 603, and a second network entity 606 associated with (e.g., supporting) a second cell 607. In certain aspects, the first network entity 602 and/or the second network entity 606 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and first network entity 602 and/or second network entity 606 may be another type of network entity or network node, such as those described herein.

In this example, first network entity 602 and second network entity 606 are associated with different RANs and implement different RATs. For example, first network entity 602 is associated with a 5G RAN and implements a 5G RAT, while second network entity 606 is associated with a 6G RAN and implements a 6G RAT. As such, first cell 603, associated with (e.g., supported by) first network entity 602, may be a 5G cell. Similarly, second cell 607, associated with (e.g., supported by) second network entity 606, may be a 6G cell. Although FIG. 6 depicts, first network entity 602 and second network entity 606 being associated with different RANs and implementing different RATs, in some other examples, first network entity 602 and second network entity 606 may be associated with a same RAN and implement a same RAT (e.g., both 5G), or different RANs and implement a same RAT.

In certain aspects, UE 604 may communicate with first network entity 602, in first cell 603, using communication link 610. Similarly, in certain aspects, UE 604 may communicate with second network entity 606, in second cell 607, using communication link 612. In certain aspects, the communication links 610, 612 may include examples of access links (e.g., Uu links). The communication links 610, 612 may include bi-directional links that can include both uplink and downlink communications. For example, UE 604 may send uplink transmissions, such as uplink control signals or uplink data signals, to first network entity 602 in first cell 603, using communication link 610. Further, first network entity 602 may send, in first cell 603, downlink transmissions, such as downlink control signals or downlink data signals, to UE 604 using the communication link 610. Similarly, UE 604 may send uplink transmissions to second network entity 606 in second cell 607, using communication link 612, and second network entity 606 may send, in second cell 607, downlink transmissions to UE 604 using the communication link 612.

In some examples, first network entity 602 may communicate with second network entity 606 via a communication link 614. In some cases, the communication link 614 may include an example of an access link (e.g., Uu links), a backhaul communication link, a midhaul communication link, or a fronthaul communication link, or any combination thereof. The communication link 614 may include bi-directional links. For example, the first network entity 602 may send transmissions, such as control signals and/or data signals, to the second network entity 606 using the communication link 614. Additionally, the second network entity 606 may send transmissions to the first network entity 602 using the communication link 614.

In this regard, the wireless communications system 600 may be configured to support multiple RATs, including current and future RATs. As future generations of RATs are developed and deployed, the wireless communications system 600 may undergo a “migration period” during which both old (e.g., “legacy”) and new RATs are supported. For example, in the context of 5G and 6G communications, the wireless communications system 600 may support both 5G and 6G devices as wireless devices are gradually “migrated”to 6G devices.

There are several different “migration schemes” that may be used for migrating between/across RATs. For example, FIG. 6 depicts a static configuration 650 and a dynamic configuration 660 that may be implemented during the migration process of the wireless communications system 600. The configurations 650, 660 depict two different implementations where different RATs (e.g., 5G and 6G) may coexist within the wireless communication system 600.

The static configuration 650 illustrates a “static refarming” configuration in which resources are divided up statically across the supported RATs in the time and/or frequency domain. With static refarming (as depicted via the static configuration 650), a network vendor may dedicate a whole component carrier (or another set of resources) to 6G communications, where there is no coexistence of multiple RATs within/across the resources. For instance, as shown in the static configuration 650, resources within a first component carrier (CC1) 654-1 (and within a given slot 652) may be allocated to 5G communications, whereas resources within a second component carrier (CC2) 654-2 may be allocated to 6G communications. The static configuration 650 may be constant across multiple slots, or may change from slot to slot.

Comparatively, the dynamic configuration 660 depicts an example of dynamic multi-RAT spectrum sharing (MRSS). With dynamic MRSS, component carriers may be dynamically shared between multiple RATs (e.g., 5G and 6G) in the time, frequency, and/or spatial domains. For instance, as shown in the dynamic configuration 660, resources within a component carrier (CC) 664 may be divided up and allocated for both 5G and 6G communications. Moreover, the division/allocation of resources across RATs may change from slot to slot. For example, the component carrier 664 may be divided up according to a first allocation scheme during a first slot 662-1, and may be divided up according to a second allocation scheme during a second slot 662-2.

There are advantages and disadvantages to both the static refarming (e.g., static configuration 650) and the dynamic MRSS (e.g., dynamic configuration 660) implementations. In particular, static refarming may help with boosting network power efficiency, thereby incentivizing operators to migrate to a new RAT. Comparatively, MRSS may be expected to bring resource utilization benefit, with a power-aware design for future RATs (e.g., 6G).

In some cases, wireless communications systems (such as the wireless communications system 600) may follow different migration scenarios or migration paths that utilize combinations of the static refarming (e.g., static configuration 650) and the dynamic MRSS (e.g., dynamic configuration 660) implementations. For example, some wireless communications systems may utilize only the static configuration 650. In such cases, the network (e.g., network vendor) may refarm some cells of the network to provide only 6G service(s). As such, the network may be made up of 5G-only cells and 6G-only cells.

In other cases, a network may include 5G-only cells, as well as 5G/6G MRSS cells. In other words, the network may implement a combination of the static configuration 650 and the dynamic configuration 660 to include some cells that support only 5G communications, and some cells that support both 5G and 6G communications (e.g., MRSS cells). In other words, some of the cells of a cell site may remain operating in 5G, while other cells may be shared with 6G RAT dynamically. In practice, it is unlikely that MRSS is enabled everywhere within a network at the same time. As such, since the process is gradual, the use of both the static configuration 650 and the dynamic configuration 660 for the migration process may allow for some cells within the network to remain 5G cells for a longer duration.

Similarly, in other cases, a network may include 6G-only cells, as well as 5G/6G MRSS cells. In other words, the network may implement a combination of the static configuration 650 and the dynamic configuration 660 to include some cells that support only 6G communications, and some cells that support both 5G and 6G communications (e.g., MRSS cells). In other words, under this implementation, some cells may be refarmed for 6G-only service, while other cells may be shared between 5G and 6G RATs dynamically. As more devices within the network become 6G-capable, some of the MRSS cells may be phased-out of 5G and converted to 6G-only cells.

Lastly, in other implementations, a network may include all 5G/6G MRSS cells. That is, the network may designate all cells in the network as dynamic MRSS cells that support both 5G and 6G communications. Over time, more and more cells may support MRSS assuming, for example, that both 5G and 6G have comparable market penetration.

As described herein, power consumption, resource consumption, and/or network energy savings issues may arise when supporting multiple RANs, such as with different RATs, within a network. For example, there may be cases where second cell 607 does not include any 6G devices and thus is not serving any 6G devices, such as 6G-capable UEs. When second cell 607 is not serving the UEs, the second cell 607 may be placed in a deep level of sleep (e.g., in a sleep state) for power savings. For example, the second cell 607 may be idle and may not send broadcast common signals while in the sleep state. The second cell 607 may save energy by sending the broadcast common signals when serving the UEs instead of sending the broadcast common signals periodically. In some other cases, the second cell 607 may not send broadcast common signals without being placed in the sleep state.

In some cases, the first cell 603 may be in an awake state and transmitting broadcast common signals. When the second cell 607 is in the sleep state or simply not broadcasting signals, a 6G-capable UE, such as UE 604, may request access to second network entity 606 via the second cell 607. Since the second cell 607 is in the power saving mode, the second network entity 606 may not be able to perform the initial access procedure or RACH procedure directly with UE 604 in the second cell 607. In some cases, the first cell 603 may assist the UE 604 to access the second cell 607. For example, the first network entity 602 (1) may exchange signaling (e.g., system information) with the UE 604 in the first cell 603 and (2) may send signaling to the second network entity 606 to wake up the second cell 607. In some examples, the first network entity 602 may decide whether the UE 604 may access the second network entity 606, via the second cell 607, for load balancing purposes.

In some examples, when the second cell 607 is in a sleep state (e.g., idle) and the UE 604 wants to request access to the second network entity 606 in the second cell 607, the first cell 603 may determine to wake up the second cell 607. When the second cell 607 is idle, the second network entity 606 may not send broadcast system information in the second cell 607. However, the first network entity 602 may send, and UE 604 may receive, a broadcast system information message 630 in the first cell 603. In some cases, the broadcast system information message 630 may include system information for connecting to the first network entity 602 via the first cell 603 and system information for connecting to the second network entity 606 via the second cell 607.

For example, the broadcast system information message 630 may include an SSB message, a SIB message (e.g., a SIB1 message), or any combination thereof. The SSB and the SIB may be SSB and SIB for connecting to first network entity 602 in the first cell 603 with additional information for connecting to the second network entity 606 in the second cell 607. In some examples, the SSB and SIB of the first cell 603 (e.g., 5G) may be extended to convey additional information for connecting to the second cell 607 (e.g., 6G) or new SSBs or new SIBs with information for connecting to the second cell 607 may be added to the broadcast system information message 630. If the SIBs for 5G are extended to convey additional information in new fields for 6G, the new fields may be ignored by 5G capable UEs. If new SIBs for 6G are included in the broadcast system information message 630, the new SIBs for 6G may not be read by the 5G capable UEs.

In some cases, the additional information added to the SIBs of the first cell 603 or the new SIBs may include system information (e.g., 6G system information) for RACH configuration in the second cell 607. For example, the system information for access in the second cell 607 may include one or more RACH sequences for transmitting a RACH message, resources associated with RACH occasions, one or more random access response search space configurations, a quantity of resource occasions in frequency, one or more second cell identifiers, or any combination thereof.

Subsequently, using the received system information, the UE 604 may send, in the first cell 603, a first random access signal 635 (e.g., a RACH preamble message or MSG1) associated with the second cell 607. For example, the first random access signal 635 may indicate a request to connect to the second network entity 606 in the second cell 607. The first random access signal 635 may be sent on a carrier or frequency associated with the first cell 603 (e.g., a 5G carrier/frequency).

Based at least in part on receiving the first random access signal 635, in certain aspects, the first network entity 602 may send, to the second network entity 606, signaling 666 that forwards (at least part of) the first random access signal 635 and a WUS 668. The WUS 668, when received by the second network entity 606, may prompt the second network entity 606 to wake up the second cell 607 (e.g., have the second cell 607 exit the sleep state/deep sleep). In certain aspects, where the second cell 607 is not in a sleep state but no communication is occurring in the second cell 607, the first network entity 602 may send, to the second network entity 606, signaling that forwards (at least part of) the first random access signal 635 and that indicates to begin/resume communication in the second cell 607.

Signaling of the RACH procedure, initiated by the UE 604 sending the first random access signal 635, may be exchanged (1) between the UE 604 and the first network entity 602 in the first cell 603 and/or (2) between the UE 604 and the second network entity 606 in the second cell 607 (after the second cell transition to an awake state).

For example, the RACH procedure may be a four-step RACH procedure, similar to the four-step RACH procedure 500a depicted and described above with respect to FIG. 5A. Signaling exchanged between the UE 604 and the first network entity 602 may include (1) the first random access signal 635 (e.g., MSG1), (2) a RAR message 670, (e.g., MSG2), (3) an uplink message 675 (e.g., MSG3), and/or (4) a downlink message 680 (e.g., MSG4). Signaling exchanged between the UE 604 and the second network entity 606 may include (1) a RAR message 685 (e.g., MSG2), (2) an uplink message 690 (e.g., MSG3), and/or (3) a downlink message 695 (e.g., MSG4).

For example, in certain aspects, UE 604 may receive the RAR message 670 (e.g., MSG2) in the first cell 603 (e.g., on a resource of the first cell 603) from the first network entity 602. In certain aspects, UE 604 may receive the RAR message 685 (e.g., MSG2) in the second cell 607 (e.g., on a resource of the second cell 607) from the second network entity 606.

In certain aspects, UE 604 may send the uplink message 675 (e.g., MSG3) in the first cell 603 (e.g., on a resource of the first cell 603) to the first network entity 602. In certain aspects, UE 604 may send the uplink message 690 (e.g., MSG3) in the second cell 607 (e.g., on a resource of the second cell 607) to the second network entity 606.

In certain aspects, UE 604 may receive the downlink message 680 (e.g., MSG4) in the first cell 603 (e.g., on a resource of the first cell 603) from the first network entity 602. In certain aspects, UE 604 may receive the downlink message 695 (e.g., MSG4) in the second cell 607 (e.g., on a resource of the second cell 607) from the second network entity 606.

In certain aspects, the downlink message 680, 695 may be used for contention resolution, the RRC connection setup may not be included in the downlink message 680, 695, and the RRC connection may be sent at a later time. In certain aspects, the downlink message 680, 695 may be used for may be used for contention resolution and an RRC connection setup. For example, the downlink message 680, 695 may include an RRC container with RRC information for the second cell 607.

In certain aspects, after the downlink message 680, 695, the UE 604 may be granted access to the second cell 607. Subsequent to establishing access to the second network entity 606 in the second cell 607, the UE 604 may communicate in the second cell 607. If access to the second cell 607 is not granted, however, the UE 604 may establish access to the first network entity 602 in the first cell 603 and may communicate in the first cell 603.

In the above-described procedure, the first cell 603 assists the UE 604 in accessing the second cell 607. Thus, the first cell 603 may be providing initial access assistance for a single assisted cell (e.g., the second cell 607).

In some other examples; however, the first cell 603 may provide initial access assistance for multiple assisted cells. That is, the first network entity 602 may provide the UE 604 with system information associated with each of the multiple assisted cells to enable (e.g., assist) the UE to establish a connection in one of the multiple assisted cells. In certain aspects, the system information associated with each of the multiple assisted cells is included in a SIB1 message sent by the first network entity 602 in the first cell 603. For example, the SIB1 message may include additional information for establishing a connection in one of the multiple assisted cells (e.g., to provide initial access assistance). In certain other aspects, the system information associated with each of the multiple assisted cells is included in other SIB message(s) sent by the first network entity 602 in the first cell 603. For example, the other SIB message(s) may include additional information for establishing a connection in one of the multiple cells (e.g., to provide initial access assistance).

Some techniques for assisting multiple assisted cells, and more specifically for providing system information associated with multiple assisted cells to a UE, may suffer from technical problems of increased initial access delay for the UE, increased network power consumption, and/or increased network resource consumption. For example, extending a SIB1 message, broadcast by first network entity 602 in first cell 603, to include system information for multiple cells may exhaust available resources during transmission (or an insufficient number of resources may be available to send the SIB1 message with the larger payload). As another example, using other SIB message(s), broadcast by first network entity 602 in first cell 603, to include system information for multiple cells may reduce initial access delay for UE 604 given other SIB message(s) may be less frequently broadcast than a SIB1 message. As another example, increasing the frequency of transmission of the other SIB message(s) including the system information for the multiple cells may lead to increased network power and/or resource consumption.

### Aspects Related to Multiple Cell Initial Access Assistance

Aspects described herein may overcome the aforementioned technical problems associated with assisting multiple assisted cells and improve upon the state of the art by introducing techniques that allow for efficient inter-cell initial access assistance for multiple cells. For example, aspects described herein may enable an anchor cell to provide initial access assistance for multiple cells while limiting initial access delay, network power consumption, and/or resource utilization. An anchor cell providing initial access assistance for multiple cells may refer to a first network entity (1) communicating with a UE in the anchor cell to assist the UE in establishing an RRC connection in one of the multiple assisted cells, such as a first assisted cell, and, in certain aspects, (2) indicating to a second network entity associated with the first assisted cell when to wake up the first assisted cell.

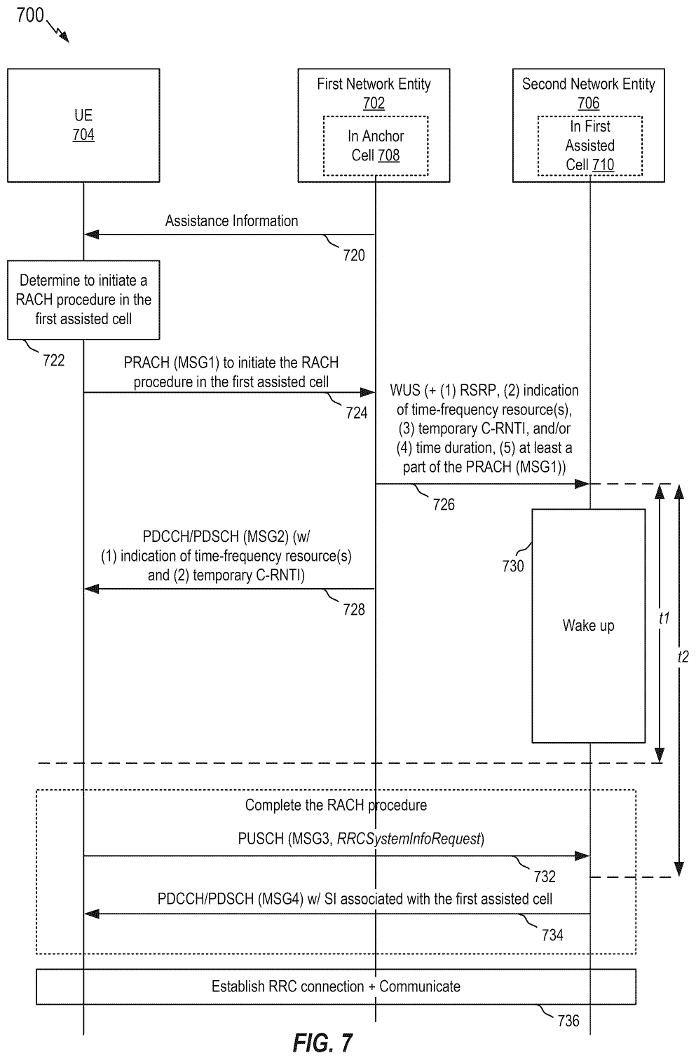

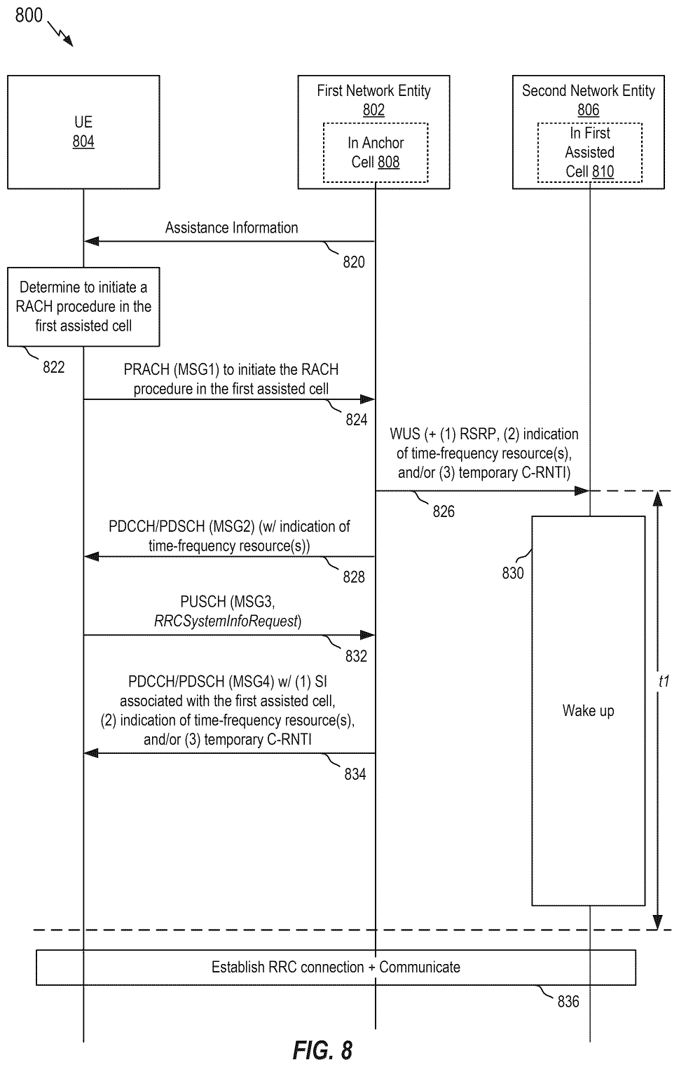

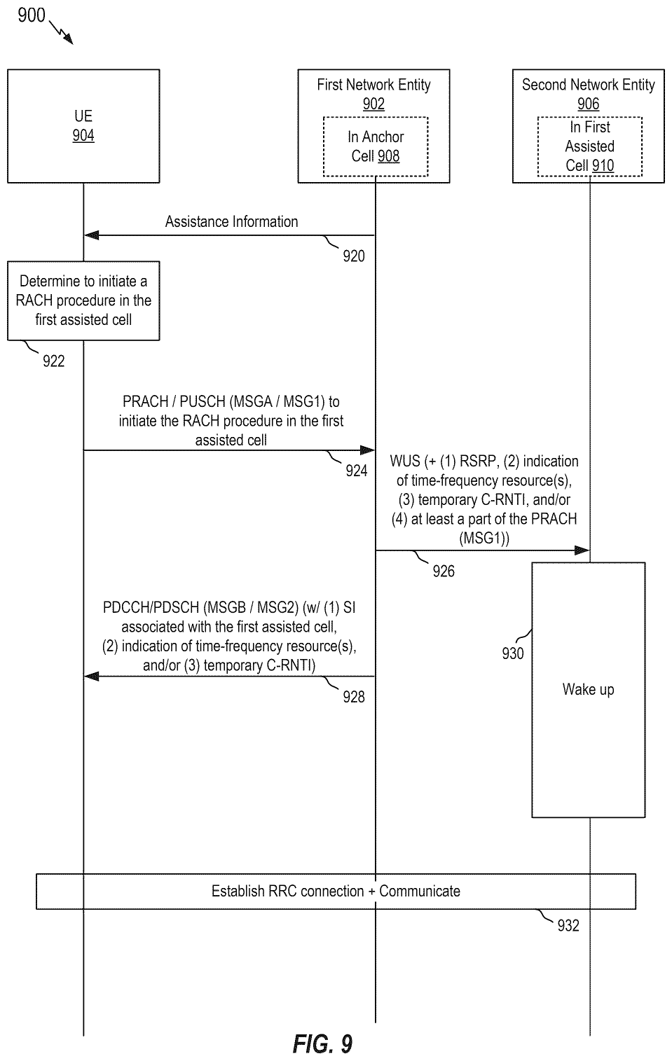

As described in detail below with respect to FIGS. 7-9, communicating with the UE may not include broadcasting system information associated with the multiple assisted cells with the UE (e.g., legacy techniques, as described above). Instead, in FIGS. 7, 8, and 9, the first network entity may send to the UE, in the anchor cell, assistance information indicating that the first network entity is capable of assisting, via the anchor cell, random access (e.g., initial access) for the multiple assisted cells. Based on receiving the assistance information, the UE may send, in the anchor cell, a random access signal (e.g., PRACH, MSG1, and/or MSGA) to initiate a RACH procedure in a first assisted cell among the multiple assisted cells. For example, in FIG. 7, a four-step RACH procedure may be performed. The four-step RACH procedure may include, at least, the UE obtaining system information associated with the first assisted cell in the first assisted cell (e.g., from the second network entity). As another example, in FIG. 8, a four-step RACH procedure may also be performed. However, the four-step RACH procedure may include, at least, the UE obtaining system information associated with the first assisted cell in the anchor cell (e.g., from the first network entity). As another example, in FIG. 9, a two-step RACH procedure may be performed. The two-step RACH procedure may include, at least, the UE obtaining system information associated with the first assisted cell in the anchor cell (e.g., from the first network entity). Thus, in the examples depicted in FIGS. 7-9, only system information for the first assisted cell may be provided to the UE (e.g., system information associated with the other assisted cells may not be provided to the UE). Put differently, the first network entity may not need to send, to the UE in the anchor cell, system information for every assisted cell that the first network entity/anchor cell assists.

### Example Signaling for Multiple Cell Initial Access Assistance

FIG. 7 depicts a process flow 700 for communications in a network between a UE 704, a first network entity 702, and a second network entity 706. In certain aspects, the first network entity 702 and/or the second network entity 706 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and first network entity 702 and/or second network entity 706 may be another type of network entity or network node, such as those described herein.

Note that the exchange of any signaling in a particular cell in process flow 700 of FIG. 7 may refer to using a carrier associated with that cell for exchanging the signaling. For example, sending and/or obtaining signals and/or data in an anchor cell 708 may refer to using an anchor carrier associated with anchor cell 708 for sending and/or obtaining the signals. Further, performing a random access procedure in a particular cell (e.g., to establish a connection with the network entity associated with the cell) may refer to using a carrier associated with that cell for communicating RACH messages.

In this example process flow 700, first network entity 702 and second network entity 706 are associated with different RANs and implement same or different RATs. For example, first network entity 702 is associated with a 5G RAN and implements a 5G RAT, while second network entity 606 is associated with a 6G RAN and implements a 6G RAT.

First network entity 702 may provide communications coverage in at least a first cell. Second network entity 706 may provide communications coverage in multiple cells, including at least a second cell. The first cell associated with first network entity 702 may be referred to as “anchor cell 708.” The second cell associated with second network entity 706 may be referred to as “first assisted cell 710” (e.g., a first assisted cell among multiple assisted cells corresponding to the second network entity 706 and/or other network entities (not shown)). In some examples, anchor cell 708 may be a 5G cell, and first assisted cell 710 may be a 6G cell.

In certain aspects, at the beginning of process flow 700, first assisted cell 710 may not be serving any UEs; thus, first assisted cell 710 may be placed in a deep level of sleep (e.g., in a sleep state) for power savings. For example, first assisted cell 710 may be idle and may not send broadcast common signals while in the sleep state. Anchor cell 708, however, may be in an awake state and may transmit broadcast common signals.

Although FIG. 7 describes first assisted cell 710 being in a sleep state prior to the beginning of process flow 700, in some other examples, first assisted cell 710 may be in an awake state; however, no communication may occur in first assisted cell 710 prior to the beginning of process flow 700 (e.g., first assisted cell 710 may not send any broadcast common signals prior to the beginning of process flow 700).

Process flow 700 begins, at 720, with UE 704 obtaining and first network entity 702 sending assistance information. For example, the assistance information may be sent by first network entity 702 and obtained by UE 704 in anchor cell 708. The assistance information may indicate that first network entity 702 is capable of assisting, via anchor cell 708, random access (e.g., including initial access) for the multiple assisted cells of second network entity 706. For example, first network entity 702 may be capable of assisting random access for first assisted cell 710, a second assisted cell (not shown), and a third assisted cell (not shown). Thus, first network entity 702 may send the assistance information, at 720 in anchor cell 708, to indicate this capability to UE 704.

In certain aspects, the assistance information does not include an indication of a number of assisted cells that first network entity 702 is capable of assisting. However, in certain other aspects, the assistance information further includes an indication of a number of assisted cells that first network entity 702 is capable of assisting. For example, when first network entity 702 is capable of assisting random access for first assisted cell 710, the second assisted cell, and the third assisted cell, the assistance information may indicate that first network entity 702 is capable of assisting random access for three assisted cells in anchor cell 708.

In certain aspects, for one or more assisted cells that first network entity 702 assists, the assistance information may include an indication of one or more time-frequency resources, corresponding to one or more random access occasions, that are associated with the respective assisted cell. For example, when first network entity 702 is capable of assisting random access for first assisted cell 710, the assistance information may include an indication of one or more time-frequency resources, corresponding to one or more random access occasions, that are associated with the first assisted cell 710, one or more RACH preambles that are associated with the first assisted cell 710, or a combination thereof. In certain aspects, the time-frequency resource(s) associated with the first assisted cell 710 may include one or more uplink resource(s) for a first random access signal (e.g., a RACH preamble message or MSG1, as depicted and described above with respect to FIG. 5A). For example, UE 704 may use the indicated time-frequency resource(s), corresponding to random access occasion(s), associated with first assisted cell 710 to indicate to first network entity 702 that UE 704 is requesting to initiate the RACH procedure in first assisted cell 710, as described in detail below.

In certain aspects, the assistance information may be included in an SSB message, an SIB message (e.g., SIB1 message), and/or another broadcast-type signal (e.g., designed to carry the assistance information), which are broadcast by first network entity 702. The SSB message and the SIB message may be SSB and SIB of anchor cell 708, for connecting to first network entity 702 in the anchor cell 708, that include the additional assistance information. For example, the SSB and SIB of the anchor cell 708 (e.g., 5G cell) may include (1) system information for connecting to anchor cell 708 and (2) the assistance information.

Although not shown in FIG. 7, in some cases, first network entity 702 may not be capable of assisting random access (e.g., including initial access) in any assisted cell. In such cases, the SSB message and/or the SIB message may not include any assistance information associated with first network entity 702. Further, the other broadcast-type signal designed to carry assistance information may not be sent by first network entity 702 in anchor cell 708.

Based on obtaining the assistance information at 720, UE 704 may realize that first network entity 702 is assisting random access for multiple assisted cells.

At 722, UE 704 determines to initiate a RACH procedure in first assisted cell 710. For example, UE 704 may determine to initiate the RACH procedure in the first assisted cell 710 to establish an RRC connection with second network entity 706 in the first assisted cell 710. This RRC connection may allow for communications between the second network entity 706 and the UE 704 in the first assisted cell 710. UE 704 may determine to initiate the RACH procedure in the first assisted cell 710 to (1) utilize additional services (e.g., 6G services) offered by second network entity 706 (e.g., a 6G network entity), (2) to improve wireless communications performance at the UE (e.g., first assisted cell 710 may be less congested than another cell, signal quality in first assisted cell 710 may be above a threshold signal quality, etc.), and/or (3) to experience higher throughout (e.g., sufficient data transfer rate may be achieved in first assisted cell 710), to name a few.

At 724, UE 704 sends, to first network entity 702 in anchor cell 708, a first random access signal (e.g., a RACH preamble message or MSG1, as depicted and described above with respect to FIG. 5A) to initiate the RACH procedure in first assisted cell 710. For example, UE 704 may use the received system information associated with anchor cell 708 to send the first random access signal in anchor cell 708. The first random access signal may be used to initiate a RACH procedure in first assisted cell 710. Put differently, UE 704 may request to establish an RRC connection with second network entity 706 in first assisted cell 710 by indicating the request via anchor cell 708 of first network entity 702. In some aspects, UE 704 may make this request to connect with second network entity 706 in the first assisted cell 710 by transmitting the first random access signal (e.g., as shown at 724 in FIG. 7) in anchor cell 708 using one or more time-frequency resources, corresponding to random access occasion(s), associated with first assisted cell 710. In some examples, reception of the first random access signal via the one or more time-frequency resources and the random access occasion(s) at first network entity 702 indicates to the first network entity 702 that UE 704 is requesting to connect with second network entity 706. As described above, UE 704 may obtain an indication of these time-frequency resource(s)/random access occasion(s) associated with the first assisted cell 710 in the assistance information (e.g., received by UE 704 at 720). In some aspects, UE 704 may include a RACH preamble (e.g., obtained at UE 704 in the assistance information at 720) in the first random access signal, where the RACH preamble indicates to first network entity 702 that UE 704 is requesting to connect with second network entity 706.

Based at least in part on obtaining the first random access signal and UE 704 using time frequency resource(s) corresponding to random access occasion(s) associated with the first assisted cell 710 to transmit the first random access signal, at 726, the first network entity 702 may send, to the second network entity 706, a WUS requesting that second network entity 706 wake up the first assisted cell 710. The WUS, when obtained by the second network entity 706, may prompt the second network entity 706 to wake up the first assisted cell 710 (e.g., have the first assisted cell 710 exit the deep sleep or transition from the sleep state to an awake state).

In certain aspects, the WUS may include a part of the first random access signal, a signal quality (e.g., RSRP) of the first random access signal, an indication of the one or more time-frequency resources corresponding to one or more random access occasions (described in detail below), and/or a temporary C-RNTI (described in detail below).

In certain aspects, the WUS may include an indication of a time duration (e.g., shown as t2 in FIG. 7) that second network entity 706 may wait to receive a third random access signal (MSG3) before returning first assisted cell 710 to the sleep state. The indication of the time duration may include information about a start time of the time duration, an end time of the time duration, a length of the time duration, and/or the like.

As shown via the block size at 730 in FIG. 7, the first assisted cell 710 may take a period of time to transition to the awake state such that second network entity 706 can communicate with UE 704 in the first assisted cell 710.

After sending the first random access signal, UE 704 may monitor a PDCCH and/or a PDSCH on the frequency (e.g., carrier) of anchor cell 708 (e.g., 5G frequency). UE 704 may obtain, at 728, based on the monitoring and based at least in part on sending the first random access signal, a second random access signal (e.g., a RAR message or MSG2) in anchor cell 708. Specifically, first network entity 702 may send, to UE 704 in anchor cell 708, the second random access signal at 728.

In certain aspects, the second random access signal at 728 may include an indication of one or more time-frequency resources corresponding to one or more random access occasions. In certain aspects, the time-frequency resource(s) include one or more uplink resource(s) for a third random access signal, or uplink message (e.g., MSG3). In certain aspects, the second random access signal at 728 may schedule the uplink message. In this example depicted in FIG. 7, the second random access signal at 728 may schedule the uplink message to be sent on time-frequency resource(s) of the first assisted cell 710 (e.g., 6G frequency/carrier) (e.g., sent in the first assisted cell 710). Further, the time-frequency resource(s) may correspond to time(s) that are expected to occur after the first assisted cell 710 has transitioned to the awake state. For example, the first assisted cell 710 may be expected to take a period of time to transition to the awake state; thus, the time associated with the time-frequency resource(s) may be after a time period (e.g., shown as t1 in FIG. 7) has passed, starting from when the WUS is obtained at second network entity 706).

In certain aspects, the second random access signal at 728 including the indication of the time-frequency resource(s) may indicate to UE 704 that UE 704 is admitted to first assisted cell 710 for RACH. For example, based on the time-frequency resource(s) being associated with a frequency or carrier of first assisted cell 710, UE 704 may determine that UE 704 may establish a connection in first assisted cell 710.

In certain aspects, when the second random access signal at 728 includes the indication of the time-frequency resource(s) (e.g., uplink resource(s)) for the uplink message (e.g., MSG3), then the WUS, sent to second network entity 706 at 726, may also include the indication of the time-frequency resource(s) (e.g., uplink resource(s)) for the uplink message (e.g., MSG3). After first assisted cell 710 transitions to the awake state, second network entity 706 may obtain the uplink message (e.g., MSG3) via the indicated time-frequency resource(s) (e.g., uplink resource(s)).

In certain aspects, the second random access signal at 728 may include a temporary cell radio network temporary identifier (C-RNTI). The C-RNTI may be subsequently used by UE 704 to detect and decode a fourth random access signal (e.g., MSG4) of the RACH procedure.

In certain aspects, when the second random access signal at 728 includes the indication of the time-frequency resource(s) (e.g., uplink resource(s)) for the uplink message (e.g., MSG3), then the WUS, sent to second network entity 706 at 726, may also include the indication of the time-frequency resource(s) (e.g., uplink resource(s)) for the uplink message (e.g., MSG3). After first assisted cell 710 transitions to the awake state, second network entity may obtain the uplink message (e.g., MSG3) using the indicated time-frequency resource(s) (e.g., the uplink resource(s)).

UE 704 may then complete the RACH procedure in first assisted cell 710. For example, at 732, UE 704 sends, to second network entity 706 in first assisted cell 710, the uplink message (e.g., MSG3). In certain aspects, UE 704 sends the uplink message on the time-frequency resource(s) indicated via the second random access signal at 728.

As described above, in certain aspects, an indication of a time duration to wait to receive the third random access signal, before returning to the sleep state, may be included in the WUS sent to second network entity 706 at 726. If the third random access signal is not sent by UE 704, and obtained by second network entity 706 in first assisted cell 710, prior to expiration of this time period, then first assisted cell 710 may return to the sleep state. For example, the WUS may include an indication of a time duration, t2, measured from a point in time when the WUS is obtained at second network entity 706. If second network entity 706 does not obtain the third access signal within this time period, t2, then second network entity 706 may cause first assisted cell 710 to return to a sleep state. Further, in certain aspects, in addition to returning to the sleep state, second network entity may send, to first network entity 702, an indication that first assisted cell 710 is returning to the sleep state.

Further, UE 704 may monitor time-frequency resource(s) (e.g., downlink resource(s)) associated with first assisted cell 710 (e.g., 6G PDCCH/PDSCH) for a fourth random access signal, or a downlink message (e.g., MSG4). Based on monitoring the time-frequency resource(s), UE 704 may obtain, from second network entity 706 in first assisted cell 710, the downlink message (e.g., MSG4) at 734. For example, second network entity 706 may send to UE 704 the downlink message at 734. In certain aspects, the downlink message may be scrambled with a C-RNTI (e.g., such as the temporary C-RNTI indicated in the WUS sent to second network entity 706 at 726).

In certain aspects, the downlink message (e.g., MSG4) may include system information associated with first assisted cell 710. The system information may include a RACH configuration associated with first assisted cell 710, an initial downlink bandwidth part (BWP) associated with first assisted cell 710, an initial uplink BWP associated with first assisted cell 710, a time division duplex (TDD) pattern associated with first assisted cell 710, and/or a physical cell identifier (PCI) associated with first assisted cell 710, to name a few.

In certain aspects, the downlink message includes an RRC container with RRC information for first assisted cell 710.

At 736, UE 704 may establish access to first assisted cell 710 and communicate with second network entity 706 in first assisted cell 710. In certain aspects, UE 704 may use the system information, obtained in the downlink message at 734, to communicate with second network entity 706 in first assisted cell 710.

In certain aspects, if access to first assisted cell 710 is unsuccessful, UE 704 may send another first random access signal to first network entity 702 in anchor cell 708. The first random access signal may be used to initiate a RACH procedure in anchor cell 708 to enable UE 704 to access anchor cell 708 (e.g., establish an RRC connection with first network entity 702).

In certain aspects, UE 704 may use a timer to determine if the RACH procedure in first assisted cell 710 has failed. In certain aspects, an indication of the timer may be provided to UE 704. For example, first network entity 702 may send, to UE 704 in anchor cell 708, an indication of the timer. The indication may include information about a starting time of the timer, an ending time for the timer, and/or a length of the timer, to name a few. In certain aspects, the specifics for the timer may be defined in wireless specifications (e.g., 3GPP specifications). In cases where the timer runs out, UE 704 may attempt to establish an RRC connection with first network entity 702 in anchor cell 708 instead.

In certain aspects, instead of using a timer, UE 704 may receive an indication of time-frequency resources that UE 704 may use to initiate a new RACH procedure in anchor cell 708 should the RACH procedure in first assisted cell 710 fail. The time-frequency resources may correspond to times after the RACH procedure in the first assisted cell 710 is expected to complete. Thus, if the RACH procedure in the first assisted cell 710 has not completed (e.g., has failed), UE 704 may use the scheduled time-frequency resources to initiate another RACH procedure in anchor cell 708 instead of first assisted cell 710. The time-frequency resources may be associated with a frequency or carrier of anchor cell 708.

Note that process flow 700 illustrated in FIG. 7 is described herein to facilitate an understanding of multiple cell inter-access assistance, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

FIG. 8 depicts a process flow 800 for communications in a network between a UE 804, a first network entity 802, and a second network entity 806. In certain aspects, the first network entity 802 and/or the second network entity 806 may be an example of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3. However, in other aspects, UE 804 may be another type of wireless communications device and first network entity 802 and/or second network entity 806 may be another type of network entity or network node, such as those described herein.

First network entity 802 may provide communications coverage in at least an anchor cell 808. Second network entity 806 may provide communications coverage in at least a first assisted cell 810.

In certain aspects, at the beginning of process flow 800, first assisted cell 810 may not be serving any UEs; thus, first assisted cell 810 may be placed in a deep level of sleep (e.g., in a sleep state) for power savings. For example, first assisted cell 810 may be idle and may not send broadcast common signals while in the sleep state. Although FIG. 8 describes first assisted cell 810 being in a sleep state prior to the beginning of process flow 800, in some other examples, first assisted cell 810 may be in an awake state; however, no communication may occur in first assisted cell 810 prior to the beginning of process flow 800 (e.g., first assisted cell 810 may not send any broadcast common signals prior to the beginning of process flow 800).

Note that exchange of any signaling in a particular cell in process flow 800 of FIG. 8 may refer to using a carrier associated with that cell for exchanging the signaling. For example, sending and/or obtaining signals and/or data in an anchor cell 808 may refer to using an anchor carrier associated with anchor cell 808 for sending and/or obtaining the signals. Further, performing a random access procedure in a particular cell (e.g., to establish a connection with the network entity associated with the cell) may refer to using a carrier associated with that cell for communicating RACH messages.

Example process flow 800 is similar to process flow 700 depicted and described with respect to FIG. 7; however, unlike process flow 700, in process flow 800 the RACH procedure, initiated by the UE is completed in the anchor cell instead of in the first assisted cell.

For example, as shown, process flow 800 includes steps 820, 822, 824, 826, and 830, which may be similar to steps 720, 722, 724, 726, and 730 depicted and described with respect to process flow 700 in FIG. 7.

Further similar to step 728 in process flow 700, at 828 in process flow 800, UE 804 may obtain a second random access signal (e.g., a RAR message or MSG2) in anchor cell 808. First network entity 802 may send, to UE 804 in anchor cell 808, the second random access signal at 828. In certain aspects, the second random access signal at 828 may include an indication of one or more time-frequency resources corresponding to one or more random access occasions. In certain aspects, the time-frequency resource(s) include one or more uplink resource(s) for a third random access signal, or uplink message (e.g., MSG3). In certain aspects, the second random access signal at 828 may schedule the uplink message. In this example depicted in FIG. 8, the second random access signal at 828 may schedule the uplink message (e.g., MSG3) to be sent on time-frequency resource(s) of anchor cell 808 (e.g., 5G frequency/carrier) (e.g., sent in anchor cell 808). This is different from process flow 700, in FIG. 7, where the second random access signal, sent at 728, schedules the uplink message to be sent on time-frequency resource(s) of the first assisted cell 710.

At 832, UE 804 sends, to first network entity 802 in anchor cell 808, the uplink message (e.g., MSG3).

UE 804 may then monitor time-frequency resource(s) (e.g., downlink resource(s)) associated with anchor cell 808 (e.g., 5G PDCCH/PDSCH) for a fourth random access signal, or a downlink message (e.g., MSG4). Based on monitoring the time-frequency resource(s), UE 804 may obtain, from first network entity 802 in anchor cell 808, the downlink message (e.g., MSG4) at 834. For example, first network entity 802 may send to UE 804 the downlink message at 834.

In certain aspects, the downlink message (e.g., MSG4) may include system information associated with first assisted cell 810. The system information may include a RACH configuration associated with first assisted cell 810, an initial downlink BWP associated with first assisted cell 810, an initial uplink BWP associated with first assisted cell 810, a TDD pattern associated with first assisted cell 810, and/or a PCI associated with first assisted cell 810, to name a few.

In certain aspects, the downlink message includes an RRC container with RRC information for first assisted cell 810.

In certain aspects, the downlink message may include an indication of one or more time-frequency resources to use for accessing first assisted cell 810 and communicating with second network entity 806 in first assisted cell 810. In certain aspects, the downlink message including the indication of the time-frequency resource(s) may indicate to UE 804 the assisted cell that UE 804 should use to connect to and establish a connection with second network entity 806. For example, based on the time-frequency resource(s) being associated with a frequency or carrier of first assisted cell 810, UE 804 may determine that UE 804 should establish a connection in first assisted cell 810.

In certain aspects, the time-frequency resource(s) may correspond to time(s) that are expected to occur after the first assisted cell 810 has transitioned to the awake state. For example, the first assisted cell 810 may be expected to take a period of time to transition to the awake state; thus, the time(s) associated with the time-frequency resource(s) may be after a time period (e.g., shown as t1 in FIG. 8) has passed, starting from when the WUS is obtained at second network entity 806).

In certain aspects, the downlink message may include a temporary C-RNTI. The C-RNTI may be subsequently used by UE 804 to detect and decode signal(s) from second network entity 806 in first assisted cell 810.

At 836, UE 804 may establish access to first assisted cell 810 and communicate with second network entity 806 in first assisted cell 810. In certain aspects, UE 804 may use the system information, obtained in the downlink message at 834, to communicate with second network entity 806 in first assisted cell 810.

Use of process flow 800 beneficially allows UE 804 to proceed with performing the RACH procedure while first assisted cell 810 is waking up, instead of waiting to perform the RACH procedure (e.g., in the first assisted cell 810) until after the first assisted cell 810 has transitioned to the awake state. As such, process flow 800 may reduce initial access delay of UE 804 in first assisted cell 810.

FIG. 9 depicts a process flow 900 for communications in a network between a UE 904, a first network entity 902, and a second network entity 906. In certain aspects, the first network entity 902 and/or the second network entity 906 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device and first network entity 902 and/or second network entity 906 may be another type of network entity or network node, such as those described herein.

Note that exchange of any signaling in a particular cell in process flow 900 of FIG. 9 may refer to using a carrier associated with that cell for exchanging the signaling. For example, sending and/or obtaining signals and/or data in an anchor cell 908 may refer to using an anchor carrier associated with anchor cell 908 for sending and/or obtaining the signals. Further, performing a random access procedure in a particular cell (e.g., to establish a connection with the network entity associated with the cell) may refer to using a carrier associated with that cell for communicating RACH messages.

Example process flow 900 is similar to process flow 700 depicted and described with respect to FIG. 7; however, unlike process flow 700, in process flow 900 a two-step RACH procedure is used to access first assisted cell 910 instead of a four-step RACH procedure as depicted in FIG. 7.

For example, as shown, process flow 900 includes steps 920, 922, 924, 926, and 930, which may be similar to steps 720, 722, 724, 726, and 730 depicted and described with respect to process flow 700 in FIG. 7. However, the random access signal sent at 924 may be MSGA in a two-step RACH procedure.

After sending the first random access signal (e.g., MSGA) at 924, UE 904 may monitor a PDCCH and/or a PDSCH on the frequency (e.g., carrier) of anchor cell 908 (e.g., 5G frequency). UE 904 may obtain, at 928, based on the monitoring and based at least in part on sending the first random access signal (e.g., MSGA), a second random access signal (e.g., MSGB) in anchor cell 908. Specifically, first network entity 902 may send, to UE 904 in anchor cell 908, the second random access signal at 928.

In certain aspects, the second random access signal (e.g., MSGB) may include system information associated with first assisted cell 910. The system information may include a RACH configuration associated with first assisted cell 910, an initial downlink BWP associated with first assisted cell 910, an initial uplink BWP associated with first assisted cell 910, a TDD pattern associated with first assisted cell 910, and/or a PCI associated with first assisted cell 910, to name a few.

In certain aspects, the second random access signal (e.g., MSGB) may include an RRC container with RRC information for first assisted cell 910.

In certain aspects, the second random access signal (e.g., MSGB) may include an indication of one or more time-frequency resources to use for accessing first assisted cell 910 and communicating with second network entity 906 in first assisted cell 910. In certain aspects, the second random access signal (e.g., MSGB) including the indication of the time-frequency resource(s) may indicate to UE 904 the assisted cell that UE 904 is admitted to in RACH. In certain aspects, the time-frequency resource(s) may correspond to time(s) that are expected to occur after the first assisted cell 910 has transitioned to the awake state.

In certain aspects, the second random access signal (e.g., MSGB) may include a temporary C-RNTI. The C-RNTI may be subsequently used by UE 904 to detect and decode signal(s) from second network entity 906 in first assisted cell 910.

At 932, UE 904 may establish access to first assisted cell 910 and communicate with second network entity 906 in first assisted cell 910. In certain aspects, UE 904 may use the system information, obtained in the second random access signal (e.g., MSGB) at 928, to communicate with second network entity 906 in first assisted cell 910.

### Example Operations

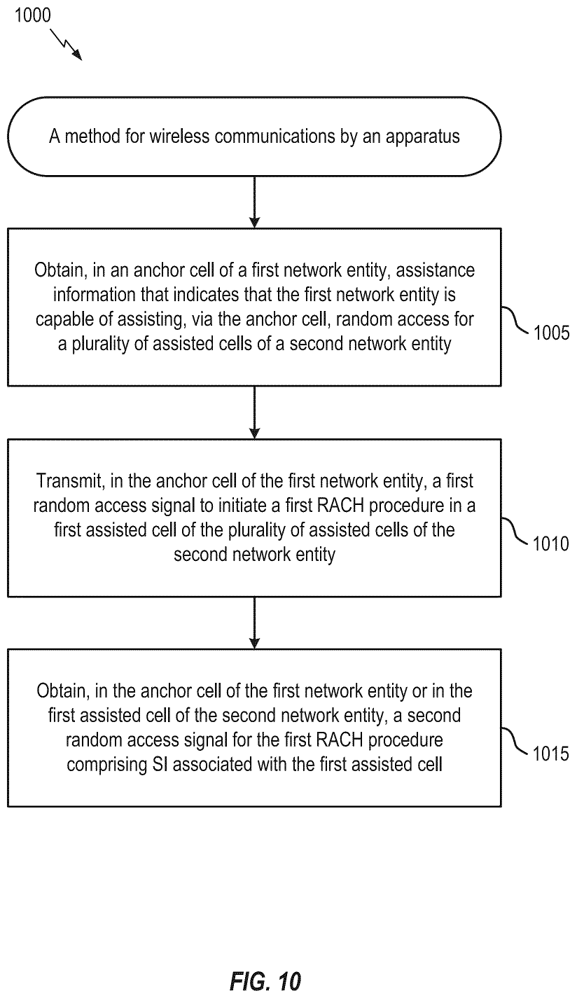

FIG. 10 shows a method 1000 for wireless communications by an apparatus, such as UE 104 of FIGS. 1 and 3.

Method 1000 begins at block 1005 with obtaining, in an anchor cell of a first network entity, assistance information that indicates that the first network entity is capable of assisting, via the anchor cell, random access for a plurality of assisted cells of a second network entity.

Method 1000 then proceeds to block 1010 with transmitting, in the anchor cell of the first network entity, a first random access signal to initiate a first RACH procedure in a first assisted cell of the plurality of assisted cells of the second network entity.

Method 1000 then proceeds to block 1015 with obtaining, in the anchor cell of the first network entity or in the first assisted cell of the second network entity, a second random access signal for the first RACH procedure comprising SI associated with the first assisted cell.

In one aspect, the first network entity is associated with a first RAN; and the second network entity is associated with a second RAN.

In one aspect, block 1005 includes obtaining, in the anchor cell of the first network entity, a synchronization signal block, a system information block, or a broadcast signal comprising the assistance information.

In one aspect, the assistance information further indicates a number of the plurality of assisted cells of the second network entity that the first network entity is capable of assisting.

In one aspect, method 1000 further includes obtaining an indication of one or more time-frequency resources corresponding to one or more random access occasions, wherein the one or more time-frequency resources correspond to an anchor carrier frequency of the anchor cell, and wherein block 1010 includes transmitting the first random access signal on at least one of the one or more time-frequency resources.

In one aspect, method 1000 further includes obtaining, in the anchor cell of the first network entity, a third random access signal for the first RACH procedure, after transmitting the first random access signal, and before obtaining the second random access signal, the third random access signal comprising: an indication of one or more time-frequency resources corresponding to one or more random access occasions; and a temporary C-RNTI associated with the second random access signal.

In one aspect, the second random access signal is scrambled with the C-RNTI.

In one aspect, a frequency of the one or more time-frequency resources corresponds to: an anchor carrier frequency of the anchor cell, or a first carrier frequency of the first assisted cell; and the method 1000 further comprises transmitting, on the one or more time-frequency resources, a fourth random access signal, prior to obtaining the second random access signal.

In one aspect, block 1015 includes obtaining the second random access signal in the first assisted cell of the second network entity.

In one aspect, block 1015 includes obtaining the second random access signal in the anchor cell of the first network entity.

In one aspect, the second random access signal further comprises an indication of one or more time-frequency resources reserved for communication with the second network entity in the first assisted cell of the second network entity.

In one aspect, the second random access signal further comprises a temporary C-RNTI.

In one aspect, method 1000 further includes transmitting, in the anchor cell of the first network entity, a third random access signal to initiate a second RACH procedure in a second assisted cell of the plurality of assisted cells of the second network entity.

In one aspect, method 1000 further includes, based on failure of the second RACH procedure to successfully complete within a time duration after the third random access signal is transmitted, transmitting, in the anchor cell of the first network entity, a fourth random access signal to initiate a third RACH procedure in the anchor cell.

In one aspect, method 1000 further includes obtaining an indication of the time duration.

In one aspect, method 1000 further includes obtaining an indication of one or more time-frequency resources corresponding to the fourth random access signal based on the failure of the second RACH procedure.

In one aspect, the SI associated with the first assisted cell comprises at least one of: a RACH configuration; an initial downlink bandwidth part; an initial uplink bandwidth part; a time division duplex pattern; or a physical cell identifier.

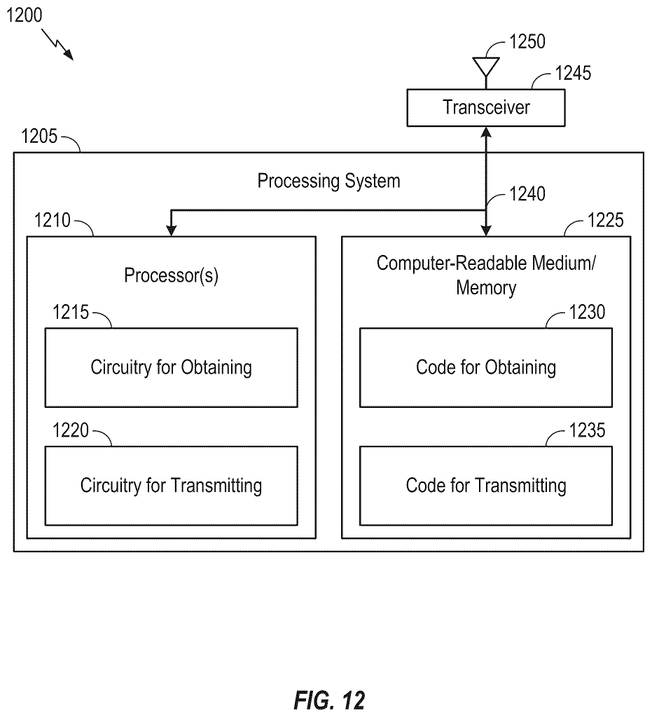

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

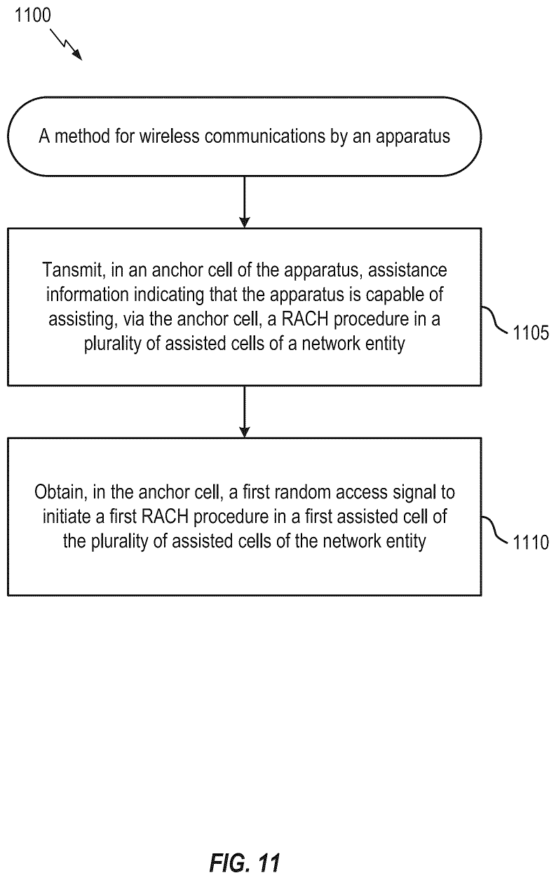

FIG. 11 shows a method 1100 for wireless communications by an apparatus, such as BS 102 of FIGS. 1 and 3, or a disaggregated base station as discussed with respect to FIG. 2.

Method 1100 begins at block 1105 with transmitting, in an anchor cell of the apparatus, assistance information indicating that the apparatus is capable of assisting, via the anchor cell, a RACH procedure in a plurality of assisted cells of a network entity.

Method 1100 then proceeds to block 1110 with obtaining, in the anchor cell, a first random access signal to initiate a first RACH procedure in a first assisted cell of the plurality of assisted cells of the network entity.

In certain aspects, method 1100 further includes transmitting, in the anchor cell of the apparatus, a second random access signal for the first RACH procedure comprising SI associated with the first assisted cell.

In one aspect, the second random access signal further comprises an indication of one or more time-frequency resources reserved for communication with the network entity in the first assisted cell of the network entity.

In one aspect, the second random access signal further comprises a temporary C-RNTI.

In one aspect, the SI associated with the first assisted cell comprises at least one of: a RACH configuration; an initial downlink bandwidth part; an initial uplink bandwidth part; a time division duplex pattern; or a physical cell identifier.

In one aspect, the apparatus is associated with a first RAN; and the network entity is associated with a second RAN.

In one aspect, block 1105 includes transmitting, in the anchor cell of the apparatus, a synchronization signal block, a system information block, or a broadcast signal comprising the assistance information.

In one aspect, the assistance information further indicates a number of the plurality of assisted cells of the network entity that the apparatus is capable of assisting.

In certain aspects, method 1100 further includes transmitting an indication of one or more time-frequency resources corresponding to one or more random access occasions, wherein the one or more time-frequency resources correspond to an anchor carrier frequency of the anchor cell, and wherein block 1110 includes obtaining the first random access signal on at least one of the one or more time-frequency resources.

In certain aspects, method 1100 further includes transmitting, in the anchor cell of the apparatus, a second random access signal for the first RACH procedure after obtaining the first random access signal, the second random access signal comprising: an indication of one or more time-frequency resources corresponding to one or more random access occasions; and a temporary C-RNTI.

In one aspect, a frequency of the one or more time-frequency resources corresponds to: an anchor carrier frequency of the anchor cell, or a first carrier frequency of the first assisted cell.

In certain aspects, method 1100 further includes transmitting, to the network entity, a WUS comprising an indication to transition the first assisted cell from a sleep state to an awake state to enable the network entity to communicate in the first assisted cell.

In one aspect, the WUS further comprises one or more of: at least a part of the first random access signal; a signal quality of the first random access signal; the indication of the one or more time-frequency resources corresponding to the one or more random access occasions; or the temporary C-RNTI.

In one aspect, the WUS further comprises an indication of a time duration to wait to receive a third random access signal before returning to the sleep state.

In certain aspects, method 1100 further includes obtaining an indication that the first assisted cell is returning to the sleep state.

In certain aspects, method 1100 further includes obtaining, in the anchor cell, a second random access signal to initiate a second RACH procedure in the anchor cell.

In certain aspects, method 1100 further includes transmitting, in the anchor cell, an indication of a time duration to wait for the first RACH procedure in the first assisted cell to complete before determining the first RACH procedure has failed and initiating a second RACH procedure in the anchor cell.

In certain aspects, method 1100 further includes transmitting, in the anchor cell, an indication of one or more time-frequency resources to use to initiate a second RACH procedure in the anchor cell based on a failure of the first RACH procedure in the first assisted cell.

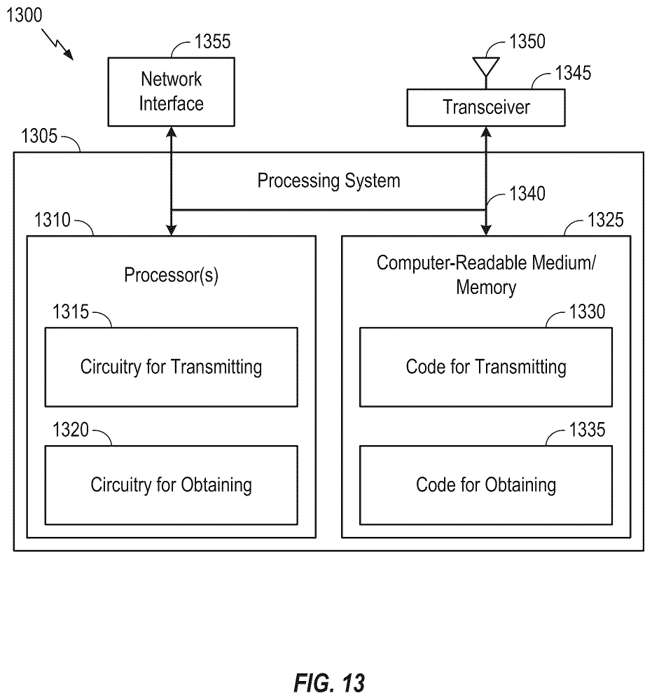

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1245 (e.g., a transmitter and/or a receiver). The transceiver 1245 is configured to transmit and receive signals for the communications device 1200 via an antenna 1250, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code), including code for obtaining 1230 and code for transmitting 1235, that when executed by the one or more processors 1210, enable and cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1225 stores code for obtaining 1230 and code for transmitting 1235. Processing of the code for obtaining 1230 and the code for transmitting 1235 may enable and cause the communications device 1200 to perform the method 1000 described with respect to FIG. 10, or any aspect related to it.

The one or more processors 1210 include circuitry configured to implement (e.g., execute) the code (e.g., executable instructions) stored in the computer-readable medium/memory 1225, including circuitry for obtaining 1215 and circuitry for transmitting 1220. Processing with circuitry for obtaining 1215 and circuity for transmitting 1220 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1245 and/or antenna 1250 of the communications device 1200 in FIG. 12, and/or one or more processors 1210 of the communications device 1200 in FIG. 12. Means for communicating, receiving or obtaining may include the transceivers 354, antenna(s) 352, receive processor 358, AI processor 370, and/or controller/processor 380 of the UE 104 illustrated in FIG. 3, transceiver 1245 and/or antenna 1250 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and transmit signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1325 via a bus 1340. In certain aspects, the computer-readable medium/memory 1325 is configured to store instructions (e.g., computer-executable code), including code for transmitting 1330 and code for obtaining 1335, that when executed by the one or more processors 1310, enable and cause the one or more processors 1310 to perform the method 1100 described with respect to FIG. 11, or any aspect related to it, including any operations described in relation to FIG. 11. Note that reference to a processor of communications device 1300 performing a function may include one or more processors of communications device 1300 performing that function, such as in a distributed fashion.

In the depicted example, the computer-readable medium/memory 1325 stores code for transmitting 1330 and code for obtaining 1335. Processing of the code for transmitting 1330 and code for obtaining 1335 may enable and cause the communications device 1300 to perform the method 1100 described with respect to FIG. 11, or any aspect related to it.

The one or more processors 1310 include circuitry configured to implement (e.g., execute) the code (e.g., executable instructions) stored in the computer-readable medium/memory 1325, including circuitry for transmitting 1315 and circuitry for obtaining 1320. Processing with circuitry for transmitting 1315 and circuity for obtaining 1320 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the transceivers 332, antenna(s) 334, receive processor 338, AI processor 318, and/or controller/processor 340 of the BS 102 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:

Implementation examples are described in the following numbered clauses:

Clause 1: A method for wireless communications by an apparatus comprising: obtaining, in an anchor cell of a first network entity, assistance information that indicates that the first network entity is capable of assisting, via the anchor cell, random access for a plurality of assisted cells of a second network entity; transmitting, in the anchor cell of the first network entity, a first random access signal to initiate a first RACH procedure in a first assisted cell of the plurality of assisted cells of the second network entity; and obtaining, in the anchor cell of the first network entity or in the first assisted cell of the second network entity, a second random access signal for the first RACH procedure comprising SI associated with the first assisted cell.

Clause 2: The method of Clause 1, wherein: the first network entity is associated with a first RAN; and the second network entity is associated with a second RAN.

Clause 3: The method of any one of Clauses 1-2, wherein obtaining the assistance information comprises obtaining, in the anchor cell of the first network entity, a synchronization signal block, a system information block, or a broadcast signal comprising the assistance information.

Clause 4: The method of any one of Clauses 1-3, wherein the assistance information further indicates a number of the plurality of assisted cells of the second network entity that the first network entity is capable of assisting.

Clause 5: The method of any one of Clauses 1-4, further comprising obtaining an indication of one or more time-frequency resources corresponding to one or more random access occasions, wherein the one or more time-frequency resources correspond to an anchor carrier frequency of the anchor cell, and wherein transmitting the first random access signal comprises transmitting the first random access signal on at least one of the one or more time-frequency resources.

Clause 6: The method of any one of Clauses 1-5, further comprising: obtaining, in the anchor cell of the first network entity, a third random access signal for the first RACH procedure, after transmitting the first random access signal, and before obtaining the second random access signal, the third random access signal comprising: an indication of one or more time-frequency resources corresponding to one or more random access occasions; and a temporary C-RNTI associated with the second random access signal.

Clause 7: The method of Clause 6, wherein the second random access signal is scrambled with the C-RNTI.

Clause 8: The method of Clause 6, wherein: a frequency of the one or more time-frequency resources corresponds to: an anchor carrier frequency of the anchor cell, or a first carrier frequency of the first assisted cell; and wherein the method further comprises transmitting, on the one or more time-frequency resources, a fourth random access signal, prior to obtaining the second random access signal.

Clause 9: The method of any one of Clauses 1-8, wherein obtaining the second random access signal comprises obtaining the second random access signal in the first assisted cell of the second network entity.

Clause 10: The method of any one of Clauses 1-9, wherein obtaining the second random access signal comprises obtaining the second random access signal in the anchor cell of the first network entity.

Clause 11: The method of Clause 10, wherein the second random access signal further comprises an indication of one or more time-frequency resources reserved for communication with the second network entity in the first assisted cell of the second network entity.

Clause 12: The method of Clause 10, wherein the second random access signal further comprises a temporary C-RNTI.

Clause 13: The method of any one of Clauses 1-12, further comprising: transmitting, in the anchor cell of the first network entity, a third random access signal to initiate a second RACH procedure in a second assisted cell of the plurality of assisted cells of the second network entity; and based on failure of the second RACH procedure to successfully complete within a time duration after the third random access signal is transmitted, transmitting, in the anchor cell of the first network entity, a fourth random access signal to initiate a third RACH procedure in the anchor cell.

Clause 14: The method of Clause 13, further comprising obtaining an indication of the time duration.

Clause 15: The method of Clause 13, further comprising obtaining an indication of one or more time-frequency resources corresponding to the fourth random access signal based on the failure of the second RACH procedure.

Clause 16: The method of any one of Clauses 1-15, wherein the SI associated with the first assisted cell comprises at least one of: a RACH configuration; an initial downlink bandwidth part; an initial uplink bandwidth part; a time division duplex pattern; or a physical cell identifier.

Clause 17: A method for wireless communications by an apparatus comprising: transmitting, in an anchor cell of the apparatus, assistance information indicating that the apparatus is capable of assisting, via the anchor cell, a RACH procedure in a plurality of assisted cells of a network entity; and obtaining, in the anchor cell, a first random access signal to initiate a first RACH procedure in a first assisted cell of the plurality of assisted cells of the network entity.

Clause 18: The method of Clause 17, further comprising: transmitting, in the anchor cell of the apparatus, a second random access signal for the first RACH procedure comprising SI associated with the first assisted cell.

Clause 19: The method of Clause 18, wherein the second random access signal further comprises an indication of one or more time-frequency resources reserved for communication with the network entity in the first assisted cell of the network entity.

Clause 20: The method of Clause 18, wherein the second random access signal further comprises a temporary C-RNTI.

Clause 21: The method of Clause 18, wherein the SI associated with the first assisted cell comprises at least one of: a RACH configuration; an initial downlink bandwidth part; an initial uplink bandwidth part; a time division duplex pattern; or a physical cell identifier.

Clause 22: The method of any one of Clauses 17-21, wherein: the apparatus is associated with a first RAN; and the network entity is associated with a second RAN.

Clause 23: The method of any one of Clauses 17-22, wherein transmitting the assistance information comprises transmitting, in the anchor cell of the apparatus, a synchronization signal block, a system information block, or a broadcast signal comprising the assistance information.

Clause 24: The method of any one of Clauses 17-23, wherein the assistance information further indicates a number of the plurality of assisted cells of the network entity that the apparatus is capable of assisting.

Clause 25: The method of any one of Clauses 17-24, further comprising transmitting an indication of one or more time-frequency resources corresponding to one or more random access occasions, wherein the one or more time-frequency resources correspond to an anchor carrier frequency of the anchor cell, and wherein obtaining the first random access signal comprises obtaining the first random access signal on at least one of the one or more time-frequency resources.

Clause 26: The method of any one of Clauses 17-25, further comprising: transmitting, in the anchor cell of the apparatus, a second random access signal for the first RACH procedure after obtaining the first random access signal, the second random access signal comprising: an indication of one or more time-frequency resources corresponding to one or more random access occasions; and a temporary C-RNTI.

Clause 27: The method of Clause 26, wherein: a frequency of the one or more time-frequency resources corresponds to: an anchor carrier frequency of the anchor cell, or a first carrier frequency of the first assisted cell.

Clause 28: The method of Clause 26, further comprising transmitting, to the network entity, a WUS comprising an indication to transition the first assisted cell from a sleep state to an awake state to enable the network entity to communicate in the first assisted cell.

Clause 29: The method of Clause 28, wherein the WUS further comprises one or more of: at least a part of the first random access signal; a signal quality of the first random access signal; the indication of the one or more time-frequency resources corresponding to the one or more random access occasions; or the temporary C-RNTI.

Clause 30: The method of Clause 28, wherein the WUS further comprises an indication of a time duration to wait to receive a third random access signal before returning to the sleep state.

Clause 31: The method of Clause 30, further comprising obtaining an indication that the first assisted cell is returning to the sleep state.

Clause 32: The method of any one of Clauses 17-31, further comprising obtaining, in the anchor cell, a second random access signal to initiate a second RACH procedure in the anchor cell.

Clause 33: The method of any one of Clauses 17-32, further comprising transmitting, in the anchor cell, an indication of a time duration to wait for the first RACH procedure in the first assisted cell to complete before determining the first RACH procedure has failed and initiating a second RACH procedure in the anchor cell.

Clause 34: The method of any one of Clauses 17-33, further comprising transmitting, in the anchor cell, an indication of one or more time-frequency resources to use to initiate a second RACH procedure in the anchor cell based on a failure of the first RACH procedure in the first assisted cell.

Clause 35: One or more apparatuses, comprising: one or more memories comprising executable instructions; and one or more processors configured to execute the executable instructions and cause the one or more apparatuses to perform a method in accordance with any one of Clauses 1-34.

Clause 36: One or more apparatuses, comprising: one or more memories; and one or more processors, coupled to the one or more memories, configured to cause the one or more apparatuses to perform a method in accordance with any one of Clauses 1-34.

Clause 37: One or more apparatuses, comprising: one or more memories; and one or more processors, coupled to the one or more memories, configured to perform a method in accordance with any one of Clauses 1-34.

Clause 38: One or more apparatuses, comprising means for performing a method in accordance with any one of Clauses 1-34.

Clause 39: One or more non-transitory computer-readable media comprising executable instructions that, when executed by one or more processors of one or more apparatuses, cause the one or more apparatuses to perform a method in accordance with any one of Clauses 1-34.

Clause 40: One or more computer program products embodied on one or more computer-readable storage media comprising code for performing a method in accordance with any one of Clauses 1-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain, in an anchor cell of a first network entity, assistance information that indicates that the first network entity is capable of assisting, via the anchor cell, random access for a plurality of assisted cells of a second network entity;
transmit, in the anchor cell of the first network entity, a first random access signal to initiate a first random access channel (RACH) procedure in a first assisted cell of the plurality of assisted cells of the second network entity; and
obtain, in the anchor cell of the first network entity or in the first assisted cell of the second network entity, a second random access signal for the first RACH procedure comprising system information (SI) associated with the first assisted cell.

2. The apparatus of claim 1, wherein:
the first network entity is associated with a first radio access network (RAN); and
the second network entity is associated with a second RAN.

3. The apparatus of claim 1, wherein to obtain the assistance information the one or more processors are configured to cause the apparatus to obtain, in the anchor cell of the first network entity, a synchronization signal block, a system information block, or a broadcast signal comprising the assistance information.

4. The apparatus of claim 1, wherein the assistance information further indicates a number of the plurality of assisted cells of the second network entity that the first network entity is capable of assisting.

5. The apparatus of claim 1, wherein:
the one or more processors are configured to cause the apparatus to obtain an indication of one or more time-frequency resources corresponding to one or more random access occasions, wherein the one or more time-frequency resources correspond to an anchor carrier frequency of the anchor cell, and
wherein to transmit the first random access signal, the one or more processors are configured to cause the apparatus to transmit the first random access signal on at least one of the one or more time-frequency resources,.

6. The apparatus of claim 1, wherein the one or more processors are further configured to cause the apparatus to:
obtain, in the anchor cell of the first network entity, a third random access signal for the first RACH procedure, after transmitting the first random access signal, and before obtaining the second random access signal, the third random access signal comprising:
an indication of one or more time-frequency resources corresponding to one or more random access occasions; and
a temporary cell radio network temporary identifier (C-RNTI) associated with the second random access signal.

7. The apparatus of claim 6, wherein the second random access signal is scrambled with the temporary C-RNTI.

8. The apparatus of claim 6, wherein:
a frequency of the one or more time-frequency resources corresponds to:
an anchor carrier frequency of the anchor cell, or
a first carrier frequency of the first assisted cell; and
wherein the one or more processors are further configured to cause the apparatus to transmit, on the one or more time-frequency resources, a fourth random access signal, prior to obtaining the second random access signal.

9. The apparatus of claim 1, wherein to obtain the second random access signal, the one or more processors are configured to cause the apparatus to obtain the second random access signal in the first assisted cell of the second network entity.

10. The apparatus of claim 1, wherein to obtain the second random access signal, the one or more processors are configured to cause the apparatus to obtain the second random access signal in the anchor cell of the first network entity.

11. The apparatus of claim 10, wherein the second random access signal further comprises an indication of one or more time-frequency resources reserved for communication with the second network entity in the first assisted cell of the second network entity.

12. The apparatus of claim 10, wherein the second random access signal further comprises a temporary cell radio network temporary identifier (C-RNTI).

13. The apparatus of claim 1, wherein the one or more processors are configured to cause the apparatus to:
transmit, in the anchor cell of the first network entity, a third random access signal to initiate a second RACH procedure in a second assisted cell of the plurality of assisted cells of the second network entity; and
based on failure of the second RACH procedure to successfully complete within a time duration after the third random access signal is transmitted, transmit, in the anchor cell of the first network entity, a fourth random access signal to initiate a third RACH procedure in the anchor cell.

14. The apparatus of claim 13, wherein the one or more processors are configured to cause the apparatus to obtain an indication of the time duration.

15. The apparatus of claim 13, wherein the one or more processors are configured to cause the apparatus to obtain an indication of one or more time-frequency resources corresponding to the fourth random access signal based on the failure of the second RACH procedure.

16. The apparatus of claim 1, wherein the SI associated with the first assisted cell comprises at least one of:
a RACH configuration;
an initial downlink bandwidth part;
an initial uplink bandwidth part;
a time division duplex pattern; or
a physical cell identifier.

17. An apparatus configured for wireless communications, comprising:
one or more memories; and
one or more processors coupled to the one or more memories, the one or more processors being configured to cause the apparatus to:
transmit, in an anchor cell of the apparatus, assistance information indicating that the apparatus is capable of assisting, via the anchor cell, a random access channel (RACH) procedure in a plurality of assisted cells of a network entity; and
obtain, in the anchor cell, a first random access signal to initiate a first RACH procedure in a first assisted cell of the plurality of assisted cells of the network entity.

18. The apparatus of claim 17, wherein the one or more processors are configured to cause the apparatus to:
transmit, in the anchor cell of the apparatus, a second random access signal for the first RACH procedure comprising system information (SI) associated with the first assisted cell.

19. The apparatus of claim 17, wherein:
the apparatus is associated with a first radio access network (RAN); and
the network entity is associated with a second RAN.

20. The apparatus of claim 17, wherein the assistance information further indicates a number of the plurality of assisted cells of the network entity that the apparatus is capable of assisting.

21. The apparatus of claim 17, wherein:
the one or more processors are configured to cause the apparatus to transmit an indication of one or more time-frequency resources corresponding to one or more random access occasions, wherein the one or more time-frequency resources correspond to an anchor carrier frequency of the anchor cell, and
wherein to obtain the first random access signal, the one or more processors are configured to cause the apparatus to obtain the first random access signal on at least one of the one or more time-frequency resources.

22. The apparatus of claim 17, wherein the one or more processors are configured to cause the apparatus to:
transmit, in the anchor cell of the apparatus, a second random access signal for the first RACH procedure after obtaining the first random access signal, the second random access signal comprising:
an indication of one or more time-frequency resources corresponding to one or more random access occasions; and
a temporary cell radio network temporary identifier (C-RNTI).

23. The apparatus of claim 22, wherein:
a frequency of the one or more time-frequency resources corresponds to:
an anchor carrier frequency of the anchor cell, or
a first carrier frequency of the first assisted cell.

24. The apparatus of claim 22, wherein the one or more processors are configured to cause the apparatus to transmit, to the network entity, a wake-up signal (WUS) comprising an indication to transition the first assisted cell from a sleep state to an awake state to enable the network entity to communicate in the first assisted cell.

25. The apparatus of claim 24, wherein the WUS further comprises one or more of:
at least a part of the first random access signal;
a signal quality of the first random access signal;
the indication of the one or more time-frequency resources corresponding to the one or more random access occasions; or
the temporary C-RNTI.

26. The apparatus of claim 24, wherein the WUS further comprises an indication of a time duration to wait to receive a third random access signal before returning to the sleep state.

27. The apparatus of claim 26, wherein the one or more processors are configured to cause the apparatus to obtain an indication that the first assisted cell is returning to the sleep state.

28. The apparatus of claim 17, wherein the one or more processors are configured to cause the apparatus to obtain, in the anchor cell, a second random access signal to initiate a second RACH procedure in the anchor cell.

29. A method for wireless communications by an apparatus comprising:
obtaining, in an anchor cell of a first network entity, assistance information that indicates that the first network entity is capable of assisting, via the anchor cell, random access for a plurality of assisted cells of a second network entity;
transmitting, in the anchor cell of the first network entity, a first random access signal to initiate a first random access channel (RACH) procedure in a first assisted cell of the plurality of assisted cells of the second network entity; and
obtaining, in the anchor cell of the first network entity or in the first assisted cell of the second network entity, a second random access signal for the first RACH procedure comprising system information (SI) associated with the first assisted cell.

30. A method for wireless communications by an apparatus comprising:
transmitting, in an anchor cell of the apparatus, assistance information indicating that the apparatus is capable of assisting, via the anchor cell, a random access channel (RACH) procedure in a plurality of assisted cells of a network entity; and
obtaining, in the anchor cell, a first random access signal to initiate a first RACH procedure in a first assisted cell of the plurality of assisted cells of the network entity.
